(19) United States
(12) Patent Application Publication
(10) Pub. No.: US 2025/0084236 A1
(43) Pub. Date: Mar. 13, 2025

(54) AN ADDITIVE MIXTURE FOR STABILIZATION OF ORGANIC MATERIAL

(71) Applicant: BASF SE, Ludwigshafen am Rhein (DE)

(72) Inventors: Tania WEYLAND, Kaisten (CH); Raphael DABBOUS, Kaisten (CH); Heinz HERBST, Kaisten (CH)

(21) Appl. No.: 18/580,070

(22) PCT Filed: Jul. 15, 2022
(86) PCT No.: PCT/EP2022/069932

§ 371 Date: Jan. 17, 2024

(30) Foreign Application Priority Data
Jul. 17, 2021 (EP) 21186273.5

(51) Int. Cl. C08K 5/3492; C08K 5/00

(52) U.S. Cl. CPC C08K 5/3492; C08K 5/0016; C08K 5/005

(57) ABSTRACT

The present invention relates to a composition comprising a stabilized organic material, at least one compound of formula (A), and at least one UV absorber. Further, the present invention relates to an additive mixture comprising at least one compound of formula (A), and at least one UV absorber. The present invention also relates to the use of the additive mixture for enhancing stability of the stabilized organic material exposed to light.

### FIELD OF THE INVENTION

The present invention relates to a composition comprising a stabilized organic material, at least one compound of formula (A), and at least one UV absorber. Further, the present invention relates to an additive mixture comprising at least one compound of formula (A), and at least one UV absorber. The present invention also relates to the use of the additive mixture for enhancing stability of the stabilized organic material exposed to light.

### BACKGROUND OF THE INVENTION

Organic materials namely synthetic polymers such as polyolefins, polyethylenes, and the like are used in wide variety of applications due to their ease of use in the manufacturing of a variety of extruded and moulded articles. However, these articles frequently suffer from general instability due to repeated exposure to the UV light. To prevent the detrimental effects of UV light on the articles prepared from the organic material, different additives for e.g. hindered amine light stabilizers, UV absorbers etc are used. However, these additives or mixture of these additives are not able to improve the stability of the organic material to a greater extent.

Thus, it is an object of the present invention to overcome the above-mentioned drawback and to provide an additive mixture for stabilizing the organic material.

### SUMMARY OF THE INVENTION

Surprisingly, it has been found that the additive mixture of the presently claimed invention i.e., combination of a UV absorber and/or HALS with a compound of formula (A) and a stabilized organic material improves durability of the end article which is exposed to light, and thus prolongs the lifetime of the end article and that results in economic value.

Thus, in one aspect, the presently claimed invention is directed to a composition comprising:
i. a stabilized organic material;
ii. at least one compound of formula (A),

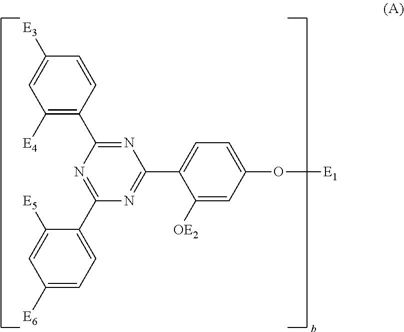

Wherein,
E1 is hydrogen, C₁-C₁₈ alkyl, a group of formula P

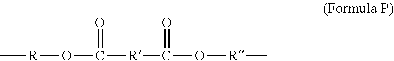

wherein, R, R′ and R″ independently of one another are C₁-C₁₈ alkylene,
b is an integer in the range of 1 to 3, or
a group of formula Q

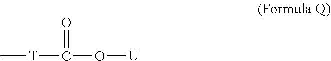

wherein, T and U independently of one another are linear or branched C₁-C₁₈ alkyl, and
E₂, E₃, E₄, E₅, and E₆ independently of one another are hydrogen, C₁-C₁₈ alkyl, phenyl or phenyl substituted by 1, 2 or 3 C₁-C₄ alkyl, or a group of formula Q

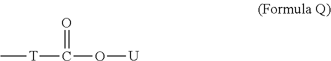

wherein, T and U independently of one another are linear or branched C₁-C₁₈ alkyl; and
iii. at least one UV absorber.

In another aspect, the presently claimed invention is directed to an additive mixture comprising:
I. at least one compound of formula (A) as defined above, and
II. at least one UV absorber.

In yet another aspect of the presently claimed invention, the presently claimed invention is directed to the use of the additive mixture for enhancing stability of the stabilized organic material exposed to light.

### DETAILED DESCRIPTION OF THE INVENTION

Before the present compositions and formulations of the invention are described, it is to be under-stood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless other-wise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “a preferred embodiment” means that a particular feature, structure or characteristic described in connection with the embodiment is included in at least one embodiment of the presently claimed invention. Thus, appearances of the phrases “in one embodiment” or “in a preferred embodiment” or “in another embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well i.e. a range of 1 to 10 implies that both 1 and 10 are included in the range. For the avoidance of doubt, the applicant shall be entitled to any equivalents according to the applicable law.

Certain terms are first defined so that this disclosure can be more readily understood. Unless defined otherwise, all technical and scientific terms used herein have the same meaning as commonly understood by one of ordinary skill in the art to which embodiments of the invention pertain.

In an aspect, the presently claimed invention is directed to a composition comprising:
i. a stabilized organic material;
ii. at least one compound of formula (A),

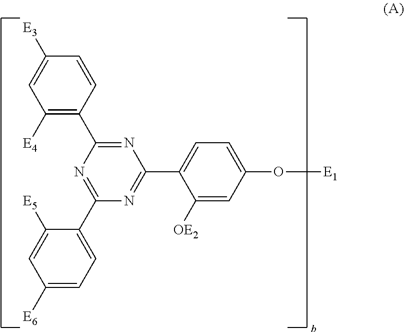

Wherein,
E1 is hydrogen, C₁-C₁₈ alkyl, a group of formula P

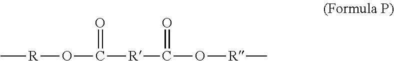

wherein, R, R′ and R″ independently of one another are C₁-C₁₈ alkylene,
b is an integer in the range of 1 to 3, or
a group of formula Q

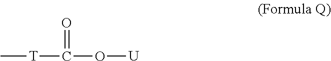

wherein, T and U independently of one another are linear or branched C₁-C₁₈ alkyl, and
E₂, E₃, E₄, E₅, and E₆ independently of one another are hydrogen, C₁-C₁₈ alkyl, phenyl or phenyl substituted by 1, 2 or 3 C₁-C₄ alkyl, or a group of formula Q

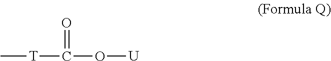

wherein, T and U independently of one another are linear or branched C₁-C₁₈ alkyl; and
iii. at least one UV absorber.

In an embodiment, the stabilized organic material is selected from the group consisting of polyethylene, polypropylene, polyurethane, styrenic polymer, a polyvinylchloride, and mixtures thereof.

In a preferred embodiment, the stabilized organic material is polyvinylchloride. The polyvinylchloride is rigid, semirigid, or a flexible polyvinylchloride.

In an embodiment, the stabilized organic material comprises at least one plasticizer, at least one heat stabilizer, and mixtures thereof.

The at least one plasticizer is selected from the group consisting of phthalates, dialkyl cyclohexan-1,2-dicarboxylates, dialkyl cyclohexan-1,3-dicarboxylates, dialkyl cyclohexan-1,4-dicarboxylates, dialkyl terephthalates, esters of trimellitic acid, trialkyltrimellitates, alkyl benzoates, dibenzoic esters of glycols, pentaerythritol esters, hydroxybenzoic esters, monoesters, esters of saturated monocarboxylic acids, esters of unsaturated monocarboxylic acids, esters of saturated dicarboxylic acids, esters of unsaturated dicarboxylic acids, amides and esters of aromatic sulfonic acids, alkylsulfonic esters, glycerol esters, glycon esters, isosorbide esters, phosphoric esters, citric triesters, acylated trialkyl citrates, alkyl pyrrolidone derivatives, dialkyl 2,5-furandicarboxylates, dialkyl 2,5-tetrahydrofurandicarboxylates, epoxide plasticizers, epoxidized vegetable oils and epoxidized fatty acid monoalkylesters, chlorinated hydrocarbons, polymer plasticizers, polyesters made of aliphatic and/or aromatic polycarboxylic acids with at least dihydric alcohols, and mixtures thereof.

The phthalate is selected from the group consisting of dimethyl phthalate, diethyl phthalate, dibutyl phthalate, dihexyl phthalate, di-2-ethylhexyl phthalate, di-n-octyl phthalate, diisooctyl phthalate, diisononyl phthalate, diisononyl hexahydrophthalate, diisodecyl phthalate, diisotridecyl phthalate, dicyclohexyl phthalate, di-methylcyclohexyl phthalate, dimethyl glycol phthalate, dibutyl glycol phthalate, benzyl butyl phthalate, and diphenyl phthalate, and mixtures of phthalates, such as C₇-C₉- and C₉-C₁₁ alkyl phthalates made from predominantly linear alcohols, C₆-C₁₀-n-alkyl phthalates and C₈-C₁₀-n-alkyl phthalates, preferably diisononyl.

The epoxide plasticizer is selected from the group consisting of epoxidized soybean oil, linseed oil and octyl oleate, preferably epoxidized soybean oil.

The at least one heat stabilizer is selected from the group consisting of metal salts of fatty acid, mixed metal stabilizers, organotin stabilizers, lead stabilizers, organic based stabilizers and mixtures thereof, preferably mixed metal stabilizers.

The metal salts of fatty acid is selected from the group consisting of calcium, zinc, magnesium or aluminium salts from the series consisting of aliphatic saturated C₂-C₂₂ carboxylates, aliphatic olefinic C₃-C₂₂ carboxylates, aliphatic C₂-C₂₂ carboxylates which are substituted by at least one OH group, cyclic or bicyclic C₅-C₂₂ carboxylates, aromatic C₇-C₂₂ carboxylates, aromatic C₇-C₂₂ carboxylates which are substituted by at least one OH group, C₁-C₁₆ alkyl-substituted phenylcarboxylates and phenyl-C₁-C₁₆ alkylcarboxylates.

The metal salts of fatty acid are selected from the group consisting of calcium stearate, zinc octanoate, zinc oleate, zinc stearate, and zinc laurate.

The mixed metal stabilizer is barium/zinc or calcium/zinc type stabilizer.

The organotin stabilizer is selected from the group consisting of organo tin mercaptester, organo tin carboxylate, and organo tin sulfide.

The lead stabilizer is selected from the group consisting of tribasic lead sulfate, dibasic lead sulfate, dibasic lead phthalate, dibasic lead phosphate, and lead stearate.

### Compound of Formula (A)

In an embodiment, the composition comprises at least one compound of formula (A)

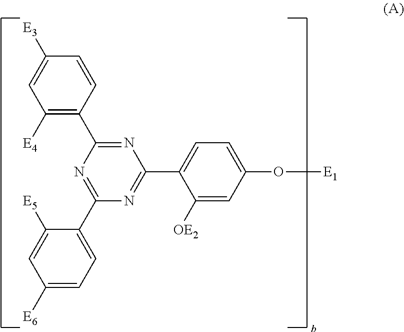

In an embodiment, E₁ is hydrogen, C₁-C₁₈ alkyl, a group of Formula P, or a group of Formula Q, preferably hydrogen, C₁-C₈ alkyl, a group of formula P

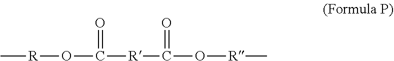

wherein, R, R′ and R″ independently of one another are C₁-C₁₈ alkylene, preferably R, R′ and R″ independently of one another are C₂-C₁₀ alkylene, b is an integer in the range of 1 to 3, preferably b is an integer in the range of 1 to 2, or a group of formula Q.

In an embodiment, when b is 1 then E₁ is hydrogen, alkyl, or a group of Formula Q and when b is 2 then E₁ is group of formula P.

In an embodiment, E₂, E₃, E₄, E₅, and E₆ independently of one another are hydrogen, C₁-C₁₈ alkyl, phenyl or phenyl substituted by 1, 2 or 3 C₁-C₄alkyl, or a group of Formula Q, preferably E₂, E₃, E₄, E₅, and E₆ independently of one another are hydrogen, C₁-C₄ alkyl, phenyl, or a group of formula Q.

Examples of alkyl having up to 18 carbon atoms are methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl and octadecyl.

Examples of alkylene having up to 18 carbon atoms are methylene, ethylene, propylene, isopropylene, n-butylene, sec-butylene, isobutylene, tert-butylene, 2-ethylbutylene, n-pentylene, isopentylene, 1-methylpentylene, 1,3-dimethylbutylene, n-hexylene, 1-methylhexylene, n-heptylene, isoheptylene, 1,1,3,3-tetramethylbutylene, 1-methylheptylene, 3-methylheptylene, n-octylene, 2-ethylhexylene, 1,1,3-trimethylhexylene, 1,1,3,3-tetramethylpentylene, nonylene, decylene, undecylene, 1-methylundecylene, dodecylene, 1,1,3,3,5,5-hexamethylhexylene, tridecylene, tetradecylene, pentadecylene, hexadecylene, heptadecylene and octadecylene.

In a preferred embodiment, the at least one compound of formula (A) is selected from the formulae (A-1), (A-2), (A-3), (A-4), and (A-5).

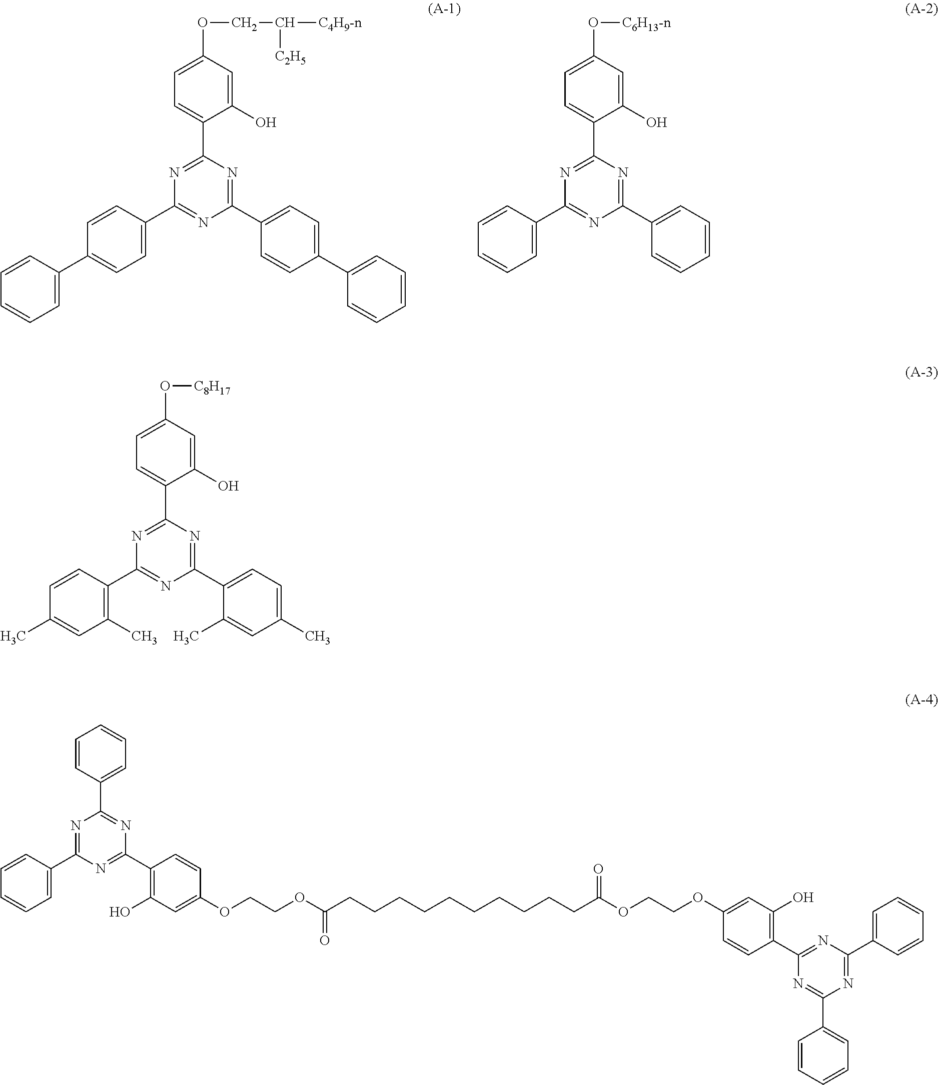

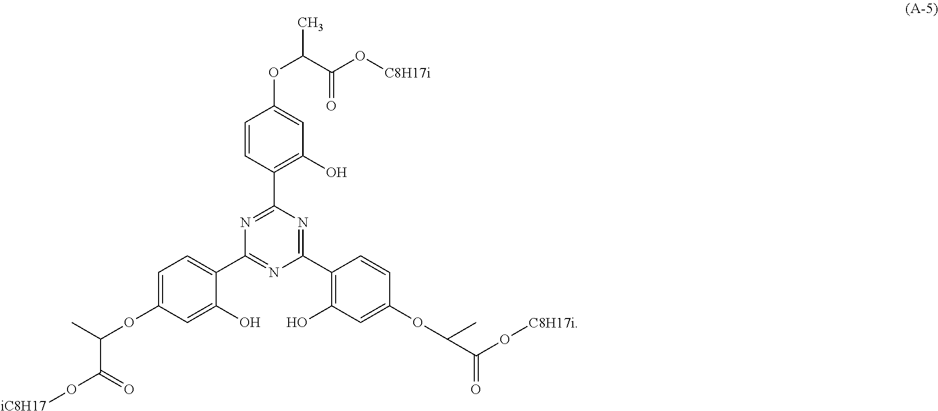

Most of the compounds of the formulae (A) are known and can be prepared in analogy to processes known to those skilled in the art.

The compounds of the formula (A) can be prepared for example in analogy to the methods described in U.S. Pat. No. 6,255,483.

In an embodiment, the UV absorber is selected from the group consisting of 2-(2′-hydroxyphenyl) benzotriazoles, 2-hydroxybenzophenones, 2-(2-hydroxyphenyl)-1,3,5-triazines, esters of substituted and unsubstituted benzoic acids, cyanoacrylates, oxanilide, benzoxazinone and mixtures thereof.

2-(2′-hydroxyphenyl) benzotriazole is selected from the group consisting of 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tertbutyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tertamyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy) carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

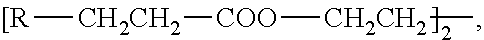

where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]benzotriazole, 2-[2′-hydroxy-3′-(1,1,3,3-tetramethylbutyl)-5′-(α,α-dimethylbenzyl)-phenyl]benzotriazole, and mixtures thereof.

In a preferred embodiment, 2-(2′-hydroxyphenyl) benzotriazoles is selected from 2-(2′-hydroxy-5′-methylphenyl)-benzotriazole, 2-(3′-tert-butyl-2′-hydroxy-5′-methylphenyl)-5-chloro-benzotriazole, and mixtures thereof.

2-hydroxybenzophenones is selected from the group consisting of 2-hydroxy-4-hydroxybenzophenone, 2-hydroxy-4-methoxybenzophenone, 2-hydroxy-4-octyloxybenzophenone, 2-hydroxy-4-decyloxybenzophenone, 2-hydroxy-4-dodecyloxybenzophenone, 2-hydroxy-4-benzyloxybenzophenone, 2-hydroxy-4,2′,4′-trihydroxybenzophenone, 2-hydroxy-2′-hydroxy-4,4′-dimethoxybenzophenone derivatives, and mixtures thereof.

In a preferred embodiment, 2-hydroxybenzophenone is 2-hydroxy-4-octyloxybenzophenone.

2-(2-hydroxyphenyl)-1,3,5-triazine is selected from the group consisting of 2,4,6-tris(2-hydroxy-4-octyloxyphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine, 2-(4,6-Bis-(2,4-dimethylphenyl)-1,3,5-triazin-2-yl)-5-(octyloxy)-phenol, bis{2-[4-(4,6-diphenyl-1,3,5-triazin-2-yl)-3-hydroxyphenoxylethyl}dodecanedioate, and mixtures thereof.

In an embodiment, esters of substituted and unsubstituted benzoic acid is selected from the group consisting of 4-tert-butyl-phenyl salicylate, phenyl salicylate, octylphenyl salicylate, dibenzoyl resorcinol, bis(4-tert-butylbenzoyl) resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-ditert-butyl-4-hydroxybenzoate and mixtures thereof, preferably 2,4-di-tert-butylphenyl 3,5-ditert-butyl-4-hydroxybenzoate.

In an embodiment, cyanoacrylate is selected from the group consisting of ethyl x-cyano-β,β-diphenylacrylate, isooctyl x-cyano-β,β-diphenylacrylate, neopentyl tetra(α-cyano-β,β-diphenylacrylate, pentaerythritol tetrakis(2-cyano-3,3-diphenylacrylate), ethyl 2-cyano-3,3-diphenylacrylate, (2-ethylhexyl)-2-cyano-3,3-diphenyl acrylate and mixtures thereof.

In a preferred embodiment, cyanoacrylate is pentaerythritol tetrakis(2-cyano-3,3-diphenylacrylate).

In an embodiment, oxanilide is selected from the group consisting of 4,4′-dioctyloxyoxanilide, 2,2′-diethoxyoxanilide, 2,2′-dioctyloxy-5,5′-di-tert-butoxanilide, 2,2′-didodecyloxy-5,5′-ditert-butoxanilide, 2-ethoxy-2′-ethyloxanilide, N,N′-bis(3-dimethylaminopropyl) oxamide, 2-ethoxy-5-tert-butyl-2′-ethoxanilide and its mixture with 2-ethoxy-2′-ethyl-5,4′-di-tertbutoxanilide, mixtures of o- and p-methoxy-disubstituted oxanilides and mixtures of o- and p-ethoxy-disubstituted oxanilides, and mixtures thereof, preferably oxanilide is 2-ethoxy-2′-ethyloxanilide.

In an embodiment, benzoxazinone is 2,2′-(1,4-Phenylene)bis[4H-3,1-benzoxazin-4-one].

In an embodiment, the composition further comprises at least one compound (B) selected from general formula (I), general formula (II), general formula (III), general formula (IV), and mixtures thereof.

### Compound (B) of General Formula (I)

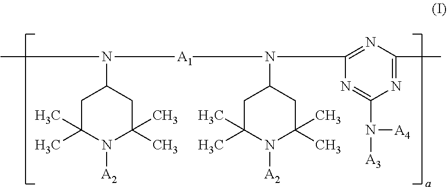

wherein
A₁ is selected from linear or branched, substituted or unsubstituted C₂-C₁₈ alkylene, substituted or unsubstituted C₅-C₇ cycloalkylene and C₁-C₄ alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂cycloalkyloxy,
A₃ and A₄ are independently selected from H, linear or branched, substituted or unsubstituted C₁-C₁₂ alkyl, substituted or unsubstituted C₅-C₁₂ cycloalkyl and a group of the formula (a-1),

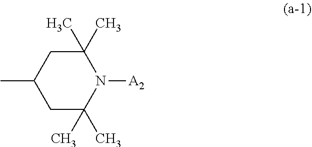

or
A₃ and A₄, together with the nitrogen atom to which they are bonded, form a 5- to 10-membered heterocyclic ring; and
a is an integer in the range of 1 to 20 and the repeating units are the same or different.

Within the context of the present invention, the term alkyl, as used herein, refers to acyclic saturated aliphatic residues, including linear or branched alkyl residues.

As used herein, “branched” denotes a chain of atoms with one or more side chains attached to it. Branching occurs by the replacement of a substituent, e.g., a hydrogen atom, with a covalently bonded aliphatic moiety.

Representative examples of linear and branched, unsubstituted C₁-C₁₂ alkyl include, but are not limited to, methyl, ethyl, n-propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, 2-propyl heptyl, n-octyl, 2-ethylhexyl, 1,1,3-trimethylhexyl, 1,1,3,3-tetramethylpentyl, n-nonyl, n-decyl, n-undecyl, isoundecyl, 1-methylundecyl, n-dodecyl, isododecyl, and 1,1,3,3,5,5-hexamethylhexyl.

Representative examples of C₁-C₁₂ alkyloxy include, but are not limited to, methoxy, ethoxy, propoxy, isopropoxy, butoxy, isobutoxy, pentoxy, isopentoxy, hexoxy, heptoxy, octoxy, nonyloxy, decyloxy, undecyloxy, and dodecyloxy.

In a preferred embodiment, alkyloxy is selected from the group consisting of methoxy, ethoxy, propoxy, isopropoxy, butoxy, isobutoxy, pentoxy, isopentoxy, hexoxy, heptoxy and octoxy. In a more preferred embodiment, alkyloxy is propoxy.

Representative examples of C₅-C₁₂ cycloalkyl are cyclopentyl, cyclohexyl, cycloheptyl, cyclooctyl, cyclononyl, cyclodecyl, cycloundecyl, and cyclododecyl.

Representative examples of C₅-C₁₂cycloalkyloxy are cyclopentoxy, cyclohexoxy, cycloheptoxy, cyclooctoxy, cyclononyloxy, cyclodecyloxy, cycloundecyloxy, and cyclododecyloxy.

In a preferred embodiment the cylcoalkyloxy is cyclohexoxy.

A preferred example of phenyl substituted by 1, 2 or 3 C₁-C₄alkyl is 2,4-dimethylphenyl.

Preferred C₂-C₁₈ alkylene are ethylene, propylene, trimethylene, tetramethylene, pentamethylene, 2,2-dimethyltrimethylene and hexamethylene. In a more preferred embodiment, alkylene is hexamethylene.

An example of C₅-C₇cycloalkylene is cyclohexylene.

An example of C₁-C₄alkylenedi (C₅-C₇cycloalkylene) is methylenedicyclohexylene.

Examples of the radicals A₃ and A₄ together with the nitrogen atom to which they are bonded, forming a 5- to 10-membered heterocyclic ring, are 1-pyrrolidyl, piperidyl, morpholinyl, 1-piperazinyl, 4-methyl-1-piperazinyl, 1-hexahydroazepinyl, 5,5,7-trimethyl-1-homopiperazinyl or 4,5,5,7-tetramethyl-1-homopiperazinyl, preferably morpholinyl.

In the compound (B) of the general formula (I) the terminal group attached to the diamino residue is for example hydrogen or a group of the formula

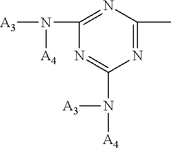

and the terminal group attached to the triazine radical is for example a group of the formula

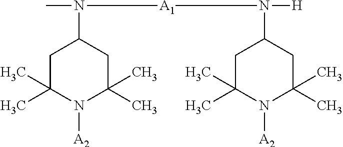

or a group of the formula

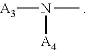

In a preferred embodiment, A₁ is hexamethylene, and A₂ is hydrogen, and propoxy.

In a preferred embodiment, A₃ is butyl,

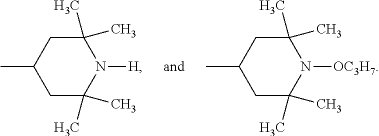

In a preferred embodiment, A₄ is butyl.

In a preferred embodiment, a is an integer in the range of 1 to 10.

### Compound (B) of General Formula (II)

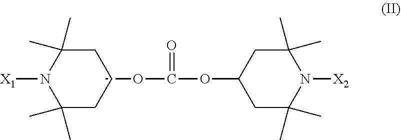

wherein
x₁ and x₂ is independently selected from C₁ to C₃₀ alkoxy,
In a preferred embodiment, x₁ and x₂ are independently selected from linear or branched, unsubstituted C₁ to C₃₀ alkyloxy.

Representative examples of linear or branched, unsubstituted C₁ to C₃₀ alkyloxy are methyloxy, ethyloxy, propyloxy, butyloxy, pentyloxy, hexyloxy, heptyloxy, octyloxy, nonyloxy, decyloxy, undecyloxy, dodecyloxy, tridecyloxy, tetradecyloxy, pentadecyloxy, hexadecyloxy, heptadecyloxy, octadecyloxy, nonadecyloxy, icosyloxy, henicosyloxy, docosyloxy, tricosyloxy, tetracosyloxy, pentacosyloxy, hexacosyloxy, heptacosyloxy, octacosyloxy, nonacosyloxy and triacontyloxy.

In a preferred embodiment, x₁ and x₂ are each undecyloxy.

### Compound (B) of General Formula (III)

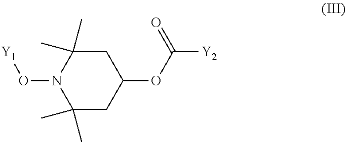

wherein
Y₁ is linear or branched, substituted or unsubstituted C₃ to C₂₀ alkyl,
Y2 is C₁ to C₃₀ alkyl; and

In a preferred embodiment, Y₁ is linear or branched, unsubstituted C₃ to C₂₀ alkyl.

In an embodiment, Y₁ is selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, and icosyl.

In a preferred embodiment, Y₁ is selected from propyl, or dodecyl.

In a preferred embodiment, Y₂ is linear or branched, unsubstituted C₁ to C₃₀ alkyl.

In an embodiment, Y₂ is selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, and triacontyl.

In a preferred embodiment, Y₂ is selected from pentadecyl, or heptadecyl.

### Compound (B) of General Formula (IV)

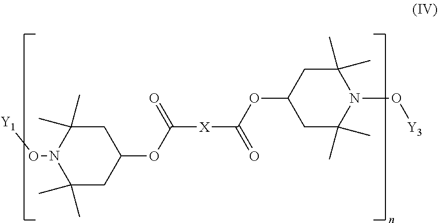

wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is C₂ to C₅ alkyl,
n is an integer in the range of 1 to 8.

In a preferred embodiment, Y₃ is selected from the group consisting of linear or branched, unsubstituted C₃ to C₂₀ alkyl and C₃ to C₂₀ alkylidene.

Representative examples of alkylidene having up to 20 carbon atoms are methylidene, ethylidene, propylidene, butylidene, pentylidene, hexylidene, heptylidene, octylidene, nonylidene, decylidene, undecylidene, dodecylidene, tridecylidene, tetradecylidene, pentadecylidene, hexadecylidene, heptadecylidene, octadecylidene, nonadecylidene, and icosylidene.

In a preferred embodiment, Y₁ is selected from decyl.

In a preferred embodiment, Y₃ is selected from decyl, or nonylidene.

In a preferred embodiment, the compound (B) is selected from the formulae (B-1), (B-2), (B-3), (B-4), (B-5), (B-6), (B-7), and (B-8).

In a more preferred embodiment, the compound (B) is the compound of formulae (B-4).

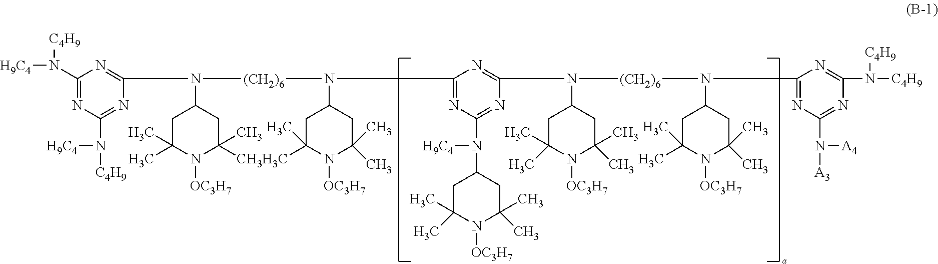

wherein a is an integer in the range of 1 to 10; and

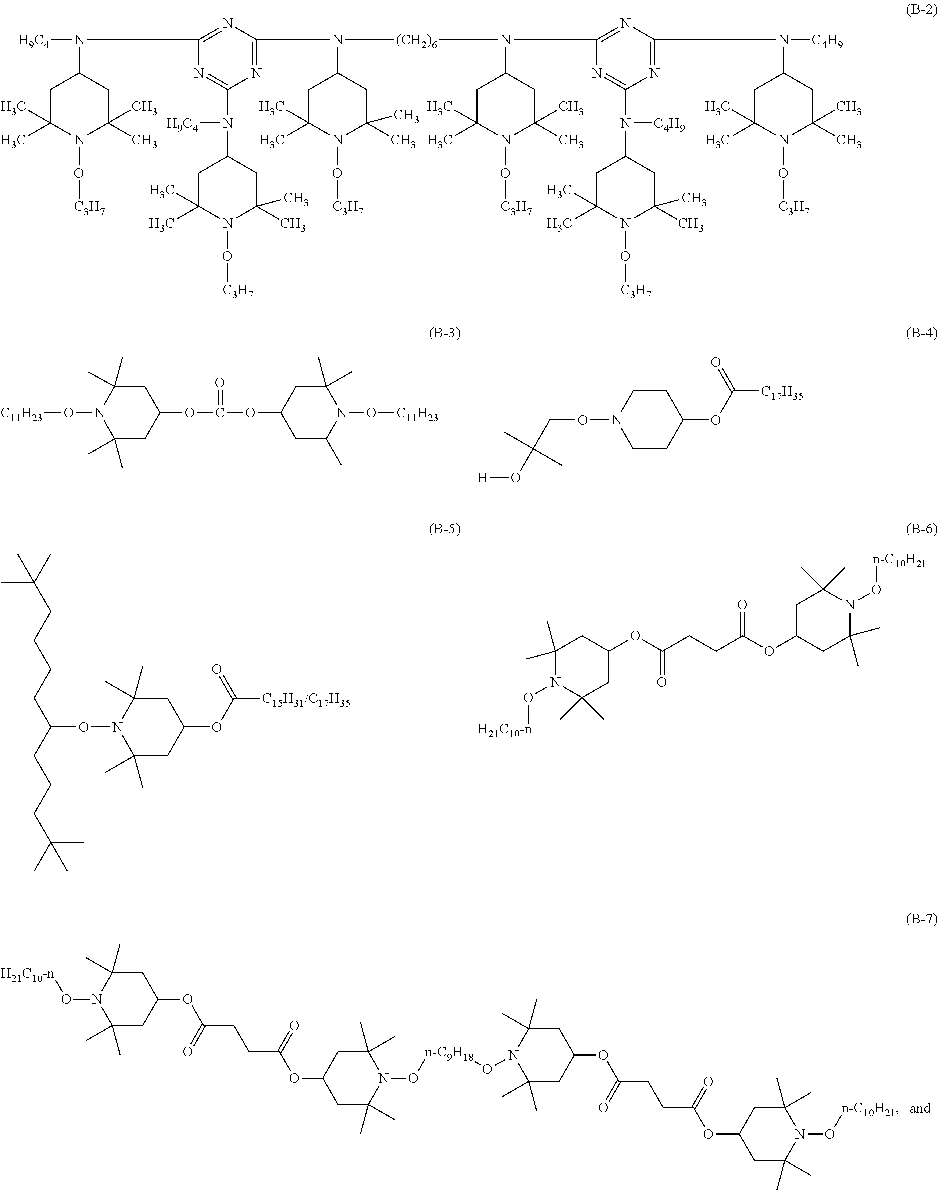

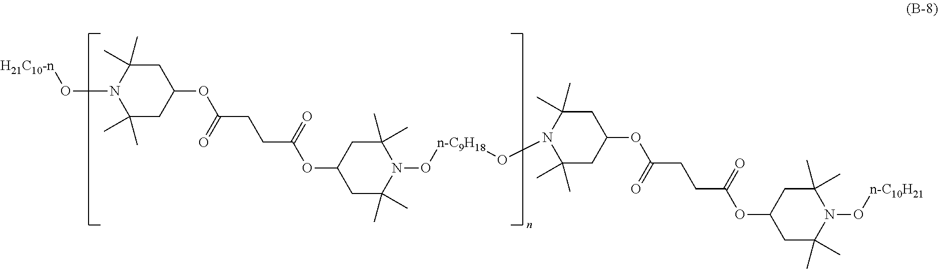

wherein n is 2.

In an embodiment, the composition further comprises at least one sterically hindered amine light stabilizer.

The at least one sterically hindered amine light stabilizer is selected from the group consisting of carbonic acid bis(1-undecyloxy-2,2,6,6-tetramethyl-4-piperidyl)ester, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine and 4-butylamino-2,2,6,6-tetramethylpiperidine; a condensate of 1,6-hexanediamine and 2,4,6-trichloro-1,3,5-triazine as well as N,N-dibutylamine and 4-butylamino-2,2,6,6-tetramethylpiperidine; N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)amino)-s-triazine, 4-N-butyl-2-N,4-N-bis(2,2,6,6-tetramethylpiperidin-4-yl)-2-N-[6-[(2,2,6,6-tetramethylpiperidin-4-yl)amino]hexyl]-1,3,5-triazine-2,4-diamine, N,N′-bis(2,2,6,6-tetramethyl-4-piperidyl)-N,N′-diformylhexamethylenediamine, 1,5,8,12-Tetrakis[4,6-bis(n-butyl-n-1,2,2,6,6-pentamethyl-4-piperidylamino)-1,3,5-triazin-2-yl]-1,5,8,12-tetraazadodecane, 1,3,5-Triazine-2,4,6-triamine, N,N′″-[1,2-ethane-diyl-bis[[[4,6-bis-[butyl(1,2,2,6,6-pentamethyl-4-piperidinyl)amino]-1,3,5-triazine-2-yl]imino]-3,1-propanediyl]]bis[N′,N″-dibutyl-N′,N″-bis(1,2,2,6,6-pentamethyl-4-piperidinyl)-, 1,6-Hexanediamine, N,N′-bis(2,2,6,6-tetramethyl-4-piperidinyl)-, Polymers with morpholine-2,4,6-trichloro-1,3,5-triazine, poly(4-hydroxy-2,2,6,6-tetramethyl-1-piperidineethanol-alt-1,4-butanedioic acid), and mixtures thereof.

In a preferred embodiment, the sterically hindered amine light stabilizers is 1,3,5-Triazine-2,4,6-triamine, N,N′″-[1,2-ethane-diyl-bis[[[4,6-bis-[butyl(1,2,2,6,6-pentamethyl-4-piperidinyl)amino]-1,3,5-triazine-2-yl]imino]-3,1-propanediyl]]bis[N′,N″-dibutyl-N′,N″-bis(1,2,2,6,6-pentamethyl-4-piperidinyl)-.

In a preferred embodiment, the sterically hindered amine light stabilizers is poly(4-hydroxy-2,2,6,6-tetramethyl-1-piperidineethanol-alt-1,4-butanedioic acid).

In an embodiment, the composition further comprises at least one additive selected from the group consisting of slip agents, anti-block agents, thermal fillers, pigments, anti-fog and antimist agents.

In an embodiment, the composition further comprises at least one impact modifier selected from the group consisting of acrylic, 2-Propenoic acid, 2-methyl-, methyl ester, polymer with butyl 2-propenoate and 2-ethylhexyl 2-propenoate, methacrylate butadiene styrene (MBS), methacrylate/acrylonitrile-butadiene-styrene (MABS), acrylnitrile-butadiene-styrene (ABS), chlorinated polyethylene (CPE), ethylene vinyl acetate (EVA), polymethylmethacrylate (PMMA), ethylene propylene diene monomer (EPDM).

In an embodiment, the weight ratio of the stabilized organic material to the total weight of at least one compound of formula (A) and at least one UV absorber is in the range of 99.9:0.1 to 99:1.

In an embodiment, the weight ratio of the at least one compound of formula (A) to the at least one UV absorber is in the range of 1:50 to 50:1.

The composition may additionally also contain various conventional additives, for example:

### 1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-ditert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tertbutyl-4-hydroxyanisole, 3,5-di-tert-butyl-4-hydroxyphenyl stearate, bis(3,5-di-tert-butyl-4-hydroxyphenyl) adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tertbutylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-ditert-butyl-4-hydroxyphenyl)propane, 2,2-bis(5-tert-butyl-4-hydroxy2-methylphenyl)-4-n-dodecylmercaptobutane, 1,1,5,5-tetra-(5-tert-butyl-4-hydroxy-2-methylphenyl)pentane.

1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bi(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane. 1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]undecane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tertbutyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, supplied by Uniroyal).

1.18. Ascorbic acid (vitamin C)

1.19. Aminic antioxidants, for example N,N′-di-isopropyl-p-phenylenediamine, N,N′-di-secbutyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tertbutyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.

### 2. UV Absorbers and Light Stabilizers

2.1. Esters of substituted and unsubstituted benzoic acids, for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.2. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-pmethoxycinnamate, N-(β-carbomethoxy-β-cyanovinyl)-2-methylindoline, neopentyl tetra(α-cyano-β,β-diphenylacrylate.

2.3. Nickel compounds, for example nickel complexes of 2,2′-thio-bis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.4. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.5. 2-(2-Hydroxyphenyl)-1,3,5-triazines, for example 2,4,6-tris(2-hydroxy-4-octyloxyphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, phosphorous acid, mixed 2,4-bis(1,1-dimethylpropyl)phenyl and 4-(1,1-dimethylpropyl)phenyl triesters (CAS: 939402-02-5), phosphorous acid, triphenyl ester, polymer with α-hydro-ω-hydroxypoly[oxy(methyl-1,2-ethanediyl)], C10-16-alkyl esters (CAS: 1227937-46-3), Triphenyl phosphite, polymer with 1,4-cyclohexanedimethanol and polypropylene glycol, C10-16 alkyl esters (CAS Reg. No. 1821217-71-3).

The following phosphites are especially preferred:

Tris(2,4-di-tert-butylphenyl) phosphite (Irgafos*168, Ciba Specialty Chemicals Inc.), tris(nonylphenyl) phosphite,

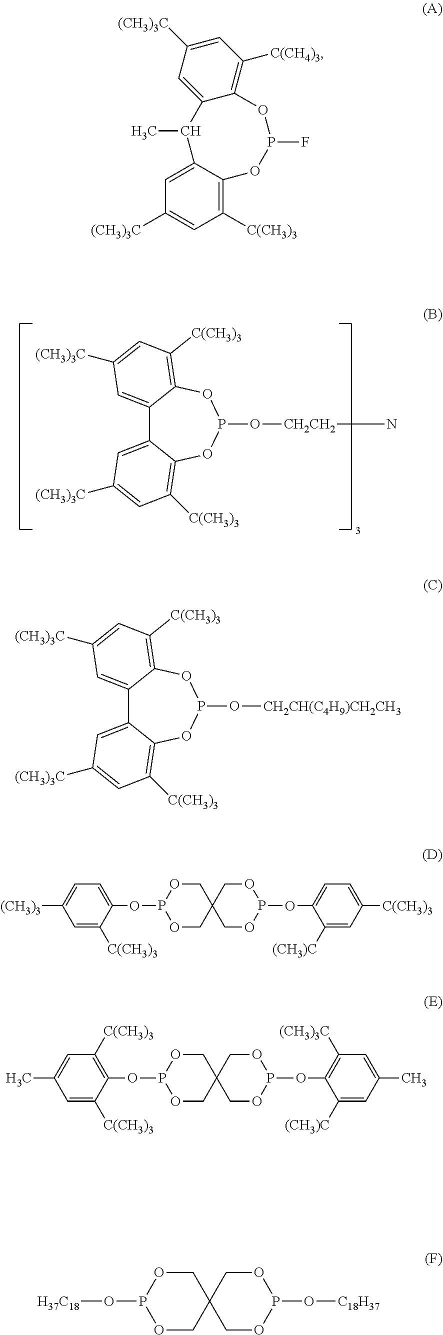

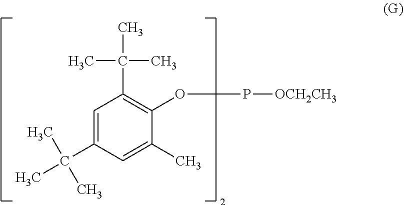

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

6. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnnitrone, N-hexadecyl-alpha-pentadecylnitrone, N-octadecyl-alpha-heptadecylnitrone, N-hexadecylalpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.

7. Thiosynergists, for example dilauryl thiodipropionate, dimistryl thiodipropionate, pentaerythritol tetrakis[3-(dodecylthio) propionate], distearyl thiodipropionate or distearyl disulfide.

8. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

9. Polyamide stabilizers, for example copper salts in combination with iodides and/or phosphorus compounds and salts of divalent manganese.

10. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(para-methyldibenzylidene)sorbitol, and 1,3:2,4-di(benzylidene)sorbitol.

12. Fillers and reinforcing agents, for example calcium carbonate, silicates, surface treated silica (as described e.g. in US-A-2007/60,697 and US-A-2009/111,918), glass fibres, glass beads, asbestos, talc, kaolin, mica, barium sulfate, metal oxides and hydroxides, carbon black, graphite, wood flour and flours or fibers of other natural products, synthetic fibers.

13. Other additives, for example plasticisers, lubricants, emulsifiers, pigments, rheology additives, catalysts, flow-control agents, optical brighteners, flameproofing agents, antistatic agents and blowing agents.

14. Benzofuranones and indolinones, for example those disclosed in U.S. Pat. Nos. 4,325,863; 4,338,244; 5,175,312; 5,216,052; 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctylbenzofuran-2-one.

In another aspect, the presently claimed invention is directed to an additive mixture comprising:
I. at least one compound of formula (A) as defined above, and
II. at least one UV absorber as defined above.

In an embodiment, the weight ratio of the at least one compound of formula (A) to the at least one UV absorber is in the range of 1:50 to 50:1.

In yet another aspect, the presently claimed invention is directed to the use of the additive mixture as defined above for enhancing stability of the stabilized organic material exposed to light.

The materials stabilized according to this invention can be used in a wide variety of forms, for example as films, fibres, tapes, moulding compositions, profiles or as binders for paints, adhesives or putties.

In more detail, the materials stabilized according to the present invention may be used for the preparation of the following devices:

I-1) Automotive applications, in particular bumpers, dashboards, battery, rear and front linings, moldings parts under the hood, hat shelf, trunk linings, interior linings, air bag covers, electronic moldings for fittings (lights), panes for dashboards, headlamp glass, instrument panel, exterior linings, upholstery, automotive lights, head lights, parking lights, rear lights, stop lights, interior and exterior trims; door panels; gas tank; glazing front side; rear windows; seat backing, exterior panels, wire insulation, profile extrusion for sealing, cladding, pillar covers, chassis parts, exhaust systems, fuel filter/filler, fuel pumps, fuel tank, body side mouldings, convertible tops, exterior mirrors, exterior trim, fasteners/fixings, front end module, glass, hinges, lock systems, luggage/roof racks, pressed/stamped parts, seals, side impact protection, sound deadener/insulator and sunroof.

I-2) Devices for plane, railway, motor car (car, motorbike) including furnishings.

I-3) Devices for space applications, in particular rockets and satellites, e.g. reentry shields.

I-4) Devices for architecture and design, mining applications, acoustic quietized systems, street refuges, and shelters.

II-1) Electric appliances, in particular washing machines, tumblers, ovens (microwave oven), dish-washers, mixers, and irons.

II-2) Foils for condensers, refrigerators, heating devices, air conditioners, encapsulating of electronics, semi-conductors, coffee machines, and vacuum cleaners.

III-1) Technical articles such as cogwheel (gear), slide fittings, spacers, screws, bolts, handles, and knobs.

III-2) Rotor blades, ventilators and windmill vanes, solar devices, swimming pools, swimming pool covers, pool liners, pond liners, closets, wardrobes, dividing walls, slat walls, folding walls, roofs, shutters (e.g. roller shutters), fittings, connections between pipes, sleeves, and conveyor belts.

III-3) Profiles of any geometry (window panes) and siding.

III-4) Glass substitutes, in particular extruded plates, glazing for buildings (monolithic, twin or multiwall), aircraft, schools, extruded sheets, window film for architectural glazing, train, transportation, sanitary articles, and greenhouse.

III-5) Plates (walls, cutting board), extrusion-coating (photographic paper, tetrapack and pipe coating), silos, wood substitute, plastic lumber, wood composites, walls, surfaces, furniture, decorative foil, floor coverings (interior and exterior applications), flooring, duck boards, and tiles.

III-6) Cement-, concrete-, composite-applications and covers, siding and cladding, hand rails, banisters, kitchen work tops, roofing, roofing sheets, tiles, and tarpaulins.

IV-1) Plates (walls and cutting board), trays, artificial grass, astroturf, artificial covering for stadium rings (athletics), artificial floor for stadium rings (athletics), and tapes.

V-1) Plastic films in general (packaging, dump, laminating, swimming pools covers, waste bags, wallpaper, stretch and shrink wrap, raffia, desalination film, batteries, and connectors).

V-2) Agricultural films (greenhouse covers, tunnel, mulch, silage, bale wrap), especially in presence of intensive application of agrochemicals).

VI-1) Food packing and wrapping (flexible and solid), BOPP, BOPET, bottles.

VI-2) Cartridges, syringes, medical applications, containers for any transportation, waste baskets and waste bins, waste bags, bins, dust bins, bin liners, wheely bins, container in general, tanks for water/used water/chemistry/gas/oil/gasoline/diesel; tank liners, boxes, crates, battery cases, troughs, medical devices such as piston, ophthalmic applications, diagnostic devices, and packing for pharmaceuticals blister.

VII-1) Devices of filled polymers (talc, chalk, china clay (kaolin), wollastonite, pigments, carbon black, TiO₂, mica, nanocomposites, dolomite, silica, silicates, glass, asbestos).

Thus, another aspect of the present invention is an article made of a composition as defined above.

The presently claimed invention offers one or more of the following advantages:
1. The articles prepared by using a combination of the UV absorber and/or HALS with the compound of formula (A) and the stabilized organic material improves durability of the end articles which are exposed to light.
2. The articles with improved durability with respect to light exposure, prolongs the lifetime of the end article.
3. The long-lasting effect of the end article results in economic value.

In the following, specific embodiments of the presently claimed invention are described:
1. A composition comprising:
   i. a stabilized organic material;
   ii. at least one compound of formula (A),

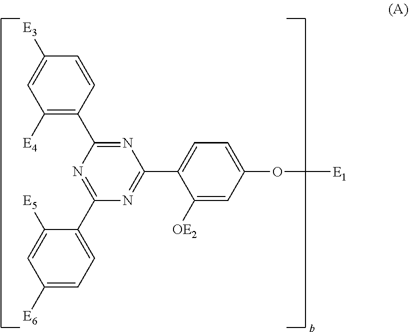

wherein
E₁ is hydrogen, C₁-C₁₈ alkyl, a group of formula P

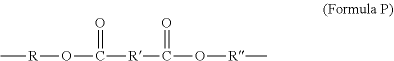

wherein, R, R′ and R″ independently of one another are C₁-C₁₈ alkylene,
b is an integer in the range of 1 to 3, or
a group of Formula Q

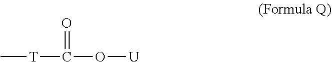

wherein, T and U independently of one another are linear or branched C₁-C₁₈alkyl,
and
E₂, E₃, E₄, E₅, and E₆ independently of one another are hydrogen, C₁-C₁₈alkyl, phenyl or phenyl substituted by 1, 2 or 3 C₁-C₄alkyl, or a group of Formula Q

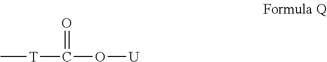

wherein, T and U independently of one another are linear or branched C₁-C₁₈alkyl; and
iii. at least one UV absorber.
2. The composition according to embodiment 1, wherein the stabilized organic material is selected from the group consisting of polyethylene, polypropylene, polyurethane, styrenic polymer, a polyvinylchloride, and mixtures thereof.
3. The composition according to embodiments 1 or 2, wherein the stabilized organic material is polyvinylchloride.
4. The composition according to one or more of embodiments 1 to 3, wherein the polyvinylchloride is rigid, semirigid, or flexible polyvinylchloride.
5. The composition according to one or more of embodiments 1 to 4, wherein the stabilized organic material comprises at least one plasticizer, at least one heat stabilizer, and mixtures thereof.
6. The composition according to embodiment 5, wherein the at least one plasticizer is selected from the group consisting of phthalates, dialkyl cyclohexan-1,2-dicarboxylates, dialkyl cyclohexan-1,3-dicarboxylates, dialkyl cyclohexan-1,4-dicarboxylates, dialkyl terephthalates, esters of trimellitic acid, trialkyltrimellitates, alkyl benzoates, dibenzoic esters of glycols, pentaerythritol esters, hydroxybenzoic esters, monoesters, esters of saturated monocarboxylic acids, esters of unsaturated monocarboxylic acids, esters of saturated dicarboxylic acids, esters of unsaturated dicarboxylic acids, amides and esters of aromatic sulfonic acids, alkylsulfonic esters, glycerol esters, glycon esters, isosorbide esters, phosphoric esters, citric triesters, acylated trialkyl citrates, alkyl pyrrolidone derivatives, dialkyl 2,5-furandicarboxylates, dialkyl 2,5-tetrahydrofurandicarboxylates, epoxide plasticizers, epoxidized vegetable oils and epoxidized fatty acid monoalkylesters, chlorinated hydrocarbons, polymer plasticizers, polyesters made of aliphatic and/or aromatic polycarboxylic acids with at least dihydric alcohols, and mixtures thereof.
7. The composition according to embodiment 6, wherein the phthalate is selected from the group consisting of dimethyl phthalate, diethyl phthalate, dibutyl phthalate, dihexyl phthalate, di-2-ethylhexyl phthalate, di-n-octyl phthalate, diisooctyl phthalate, diisononyl phthalate, diisononyl hexahydrophthalate, diisodecyl phthalate, diisotridecyl phthalate, dicyclohexyl phthalate, dimethylcyclohexyl phthalate, dimethyl glycol phthalate, dibutyl glycol phthalate, benzyl butyl phthalate, and diphenyl phthalate, and mixtures of phthalates, such as C₇-C₉- and C₉-C₁₁ alkyl phthalates made from predominantly linear alcohols, C₆-C₁₀-n-alkyl phthalates and C₈-C₁₀-n-alkyl phthalates.
8. The composition according to embodiment 6, wherein the epoxide plasticizer is selected from the group consisting of epoxidized soybean oil, linseed oil and octyl oleate.
9. The composition according to embodiment 5, wherein the at least one heat stabilizer is selected from the group consisting of metal salts of fatty acid, mixed metal stabilizers, organotin stabilizers, lead stabilizers, organic based stabilizers and mixtures thereof.
10. The composition according to embodiment 9, wherein the metal salts of fatty acid is selected from the group consisting of calcium, zinc, magnesium or aluminium salts from the series consisting of aliphatic saturated C₂-C₂₂ carboxylates, aliphatic olefinic C₃-C₂₂ carboxylates, aliphatic C₂-C₂₂ carboxylates which are substituted by at least one OH group, cyclic or bicyclic C₅-C₂₂ carboxylates, aromatic C₇-C₂₂ carboxylates, aromatic C₇-C₂₂ carboxylates which are substituted by at least one OH group, C₁-C₁₆ alkyl-substituted phenylcarboxylates and phenyl-C₁-C₁₆ alkylcarboxylates.
11. The composition according to embodiments 9 or 10, wherein the metal salts of fatty acid is selected from the group consisting of calcium stearate, zinc octanoate, zinc oleate, zinc stearate, and zinc laurate.
12. The composition according to embodiment 9, wherein the mixed metal stabilizer is barium/zinc or calcium/zinc type stabilizers.
13. The composition according to embodiment 9, wherein the organotin stabilizer is selected from the group consisting of organo tin mercaptester, organo tin carboxylate, and organo tin sulfide.
14. The composition according to embodiment 9, wherein the lead stabilizer is selected from the group consisting of tribasic lead sulfate, dibasic lead sulfate, dibasic lead phthalate, dibasic lead phosphate, and lead stearate.
15. The composition according to embodiment 1, wherein E₁ is hydrogen, C₁-C₈ alkyl, a group of formula P, or a group of formula Q and E₂, E₃, E₄, E₅, and E₆ independently of one another are hydrogen, C₁-C₄alkyl, phenyl or a group of formula Q.
16. The composition according to one or more of embodiments 1 or 15, wherein the at least one compound of formula (A) is selected from the formulae (A-1), (A-2), (A-3) and (A-4).

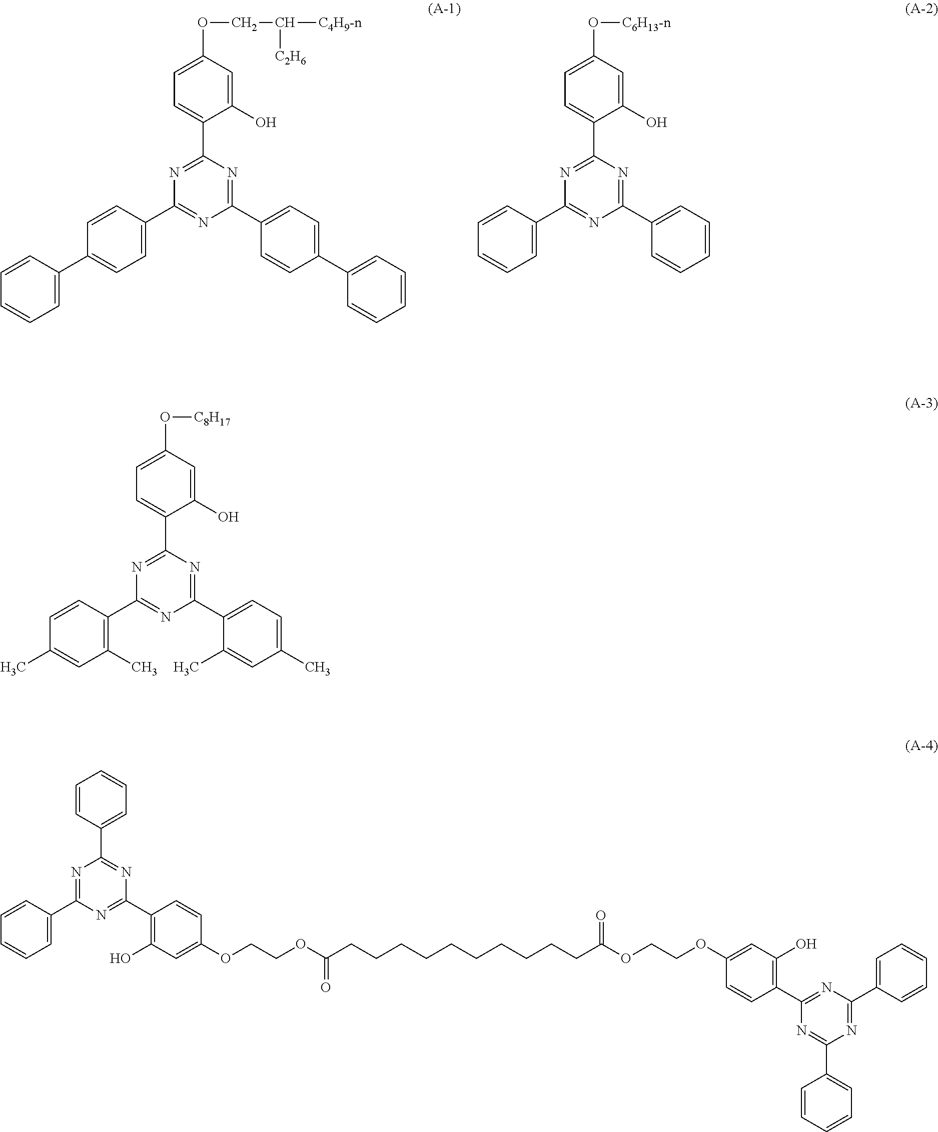

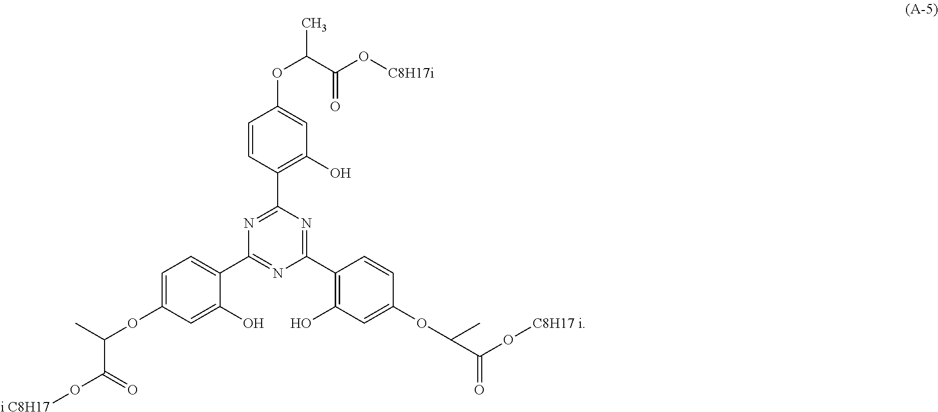

17. The composition according to embodiment 1, wherein the UV absorber is selected from the group consisting of 2-(2′-hydroxyphenyl) benzotriazoles, 2-hydroxybenzophenones, 2-(2-hydroxyphenyl)-1,3,5-triazines, esters of substituted and unsubstituted benzoic acids, cyanoacrylates, oxanilide, benzoxazinone, and mixtures thereof.
18. The composition according to embodiment 17, wherein 2-(2′-hydroxyphenyl) benzotriazole is selected from the group consisting of 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-ditert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

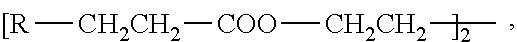

where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]benzotriazole, 2-[2′-hydroxy-3′-(1,1,3,3-tetramethylbutyl)-5′-(α,α-dimethylbenzyl)-phenyl]benzotriazole, and mixtures thereof.
19. The composition according to embodiments 17 or 18, wherein the 2-(2′-hydroxyphenyl) benzotriazoles is selected from 2-(2′-hydroxy-5′-methylphenyl)-benzotriazole, 2-(3′-tertbutyl-2′-hydroxy-5′-methylphenyl)-5-chloro-benzotriazole, and mixtures thereof.
20. The composition according to embodiment 17, wherein 2-hydroxybenzophenones is selected from the group consisting of 2-hydroxy-4-hydroxybenzophenone, 2-hydroxy-4-methoxybenzophenone, 2-hydroxy-4-octyloxybenzophenone, 2-hydroxy-4-decyloxybenzophenone, 2-hydroxy-4-dodecyloxybenzophenone, 2-hydroxy-4-benzyloxybenzophenone, 2-hydroxy-4,2′,4′-trihydroxybenzophenone, 2-hydroxy-2′-hydroxy-4,4′-dimethoxybenzophenone derivatives, and mixtures thereof.
21. The composition according to embodiments 17 or 20, wherein 2-hydroxybenzophenone is 2-hydroxy-4-octyloxybenzophenone.
22. The composition according to embodiment 17, wherein 2-(2-hydroxyphenyl)-1,3,5-triazine is selected from the group consisting of 2,4,6-tris(2-hydroxy-4-octyloxyphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-methoxyphenyl)-4,6-diphenyl-1,3,5-triazine, 2,4,6-tris[2-hydroxy4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine, 2-(4,6-Bis-(2,4-dimethylphenyl)-1,3,5-triazin-2-yl)-5-(octyloxy)-phenol, bis{2-[4-(4,6-diphenyl-1,3,5-triazin-2-yl)-3-hydroxyphenoxy]ethyl}dodecanedioate, and mixtures thereof.
23. The composition according to embodiment 17, wherein esters of substituted and unsubstituted benzoic acid is selected from the group consisting of 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate and mixtures thereof.
24. The composition according to embodiments 17 or 23, wherein esters of substituted and unsubstituted benzoic acid is 2,4-di-tert-butylphenyl 3,5-di-tert-butyl-4-hydroxybenzoate.
25. The composition according to embodiment 17, wherein cyanoacrylates is selected from the group consisting of ethyl α-cyano-β,β-diphenylacrylate, isooctyl α-cyano-β,β-diphenylacrylate, neopentyl tetra((α-cyano-β,β-diphenylacrylate, pentaerythritol tetrakis(2-cyano-3,3-diphenylacrylate), ethyl 2-cyano-3,3-diphenylacrylate, (2-ethylhexyl)-2-cyano-3,3-diphenyl acrylate and mixtures thereof.
26. The composition according to embodiment 17, wherein oxanilide is selected from the group consisting of 4,4′-dioctyloxyoxanilide, 2,2′-diethoxyoxanilide, 2,2′-dioctyloxy-5,5′-ditert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides, and mixtures thereof.
27. The composition according to embodiments 17 or 26, wherein oxanilide is 2-ethoxy-2′-ethyloxanilide.
28. The composition according to embodiment 17, wherein benzoxazinone is 2,2′-(1,4-Phenylene)bis[4H-3,1-benzoxazin-4-one].
29. The composition according to one or more of embodiments 1 to 28 further comprising at least one compound of formula (B) of general formula (I), general formula (II), general formula (III) and general formula (IV)
   compound (B) of general formula (I)

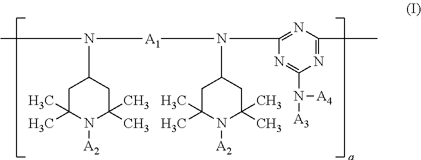

wherein
A₁ is selected from linear or branched, substituted or unsubstituted C₂-C₁₈ alkylene, substituted or unsubstituted C₅-C₇ cycloalkylene and C₁-C₄alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂cycloalkyl and C₅-C₁₂cycloalkyloxy,
A₃ and A₄ are independently selected from H, linear or branched, substituted or unsubstituted C₁-C₁₂ alkyl, substituted or unsubstituted C₅-C₁₂ cycloalkyl and a group of the formula (a-1),

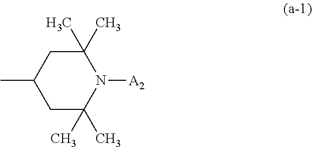

or
A₃ and A₄, together with the nitrogen atom to which they are bonded, form a 5- to 10-membered heterocyclic ring; and
a is an integer in the range of 1 to 20 and the repeating units are the same or different;
compound (B) of general formula (II)

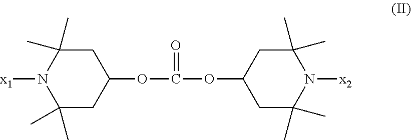

wherein
x₁ and x₂ is independently selected from C₁ to C₃₀ alkoxy,
compound (B) of general formula (III)

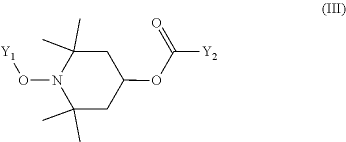

wherein
Y₁ is linear or branched, substituted or unsubstituted C₃ to C₂₀ alkyl,
Y2 is C₁ to C₃₀ alkyl; and
compound (B) of general formula (IV)

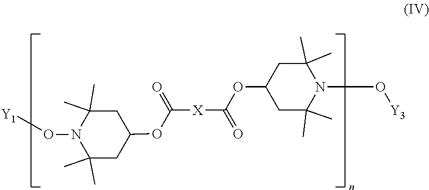

wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is C₂ to C₅ alkyl,
n is an integer in the range of 1 to 8.
30. The composition according to embodiment 29, wherein the compound of formula (B) is selected from the formulae (B-1), (B-2), (B-3), (B-4), (B-5), (B-6), (B-7), or (B-8).

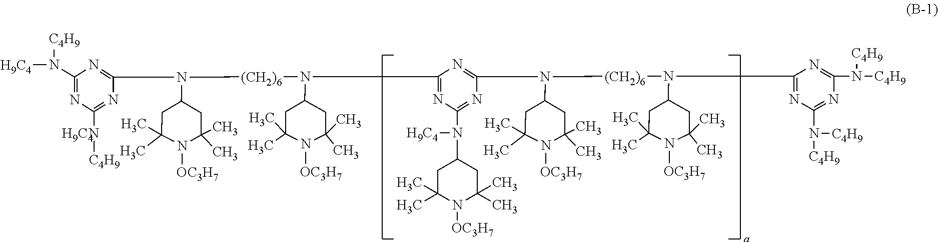

wherein a is an integer in the range of 1 to 10; and

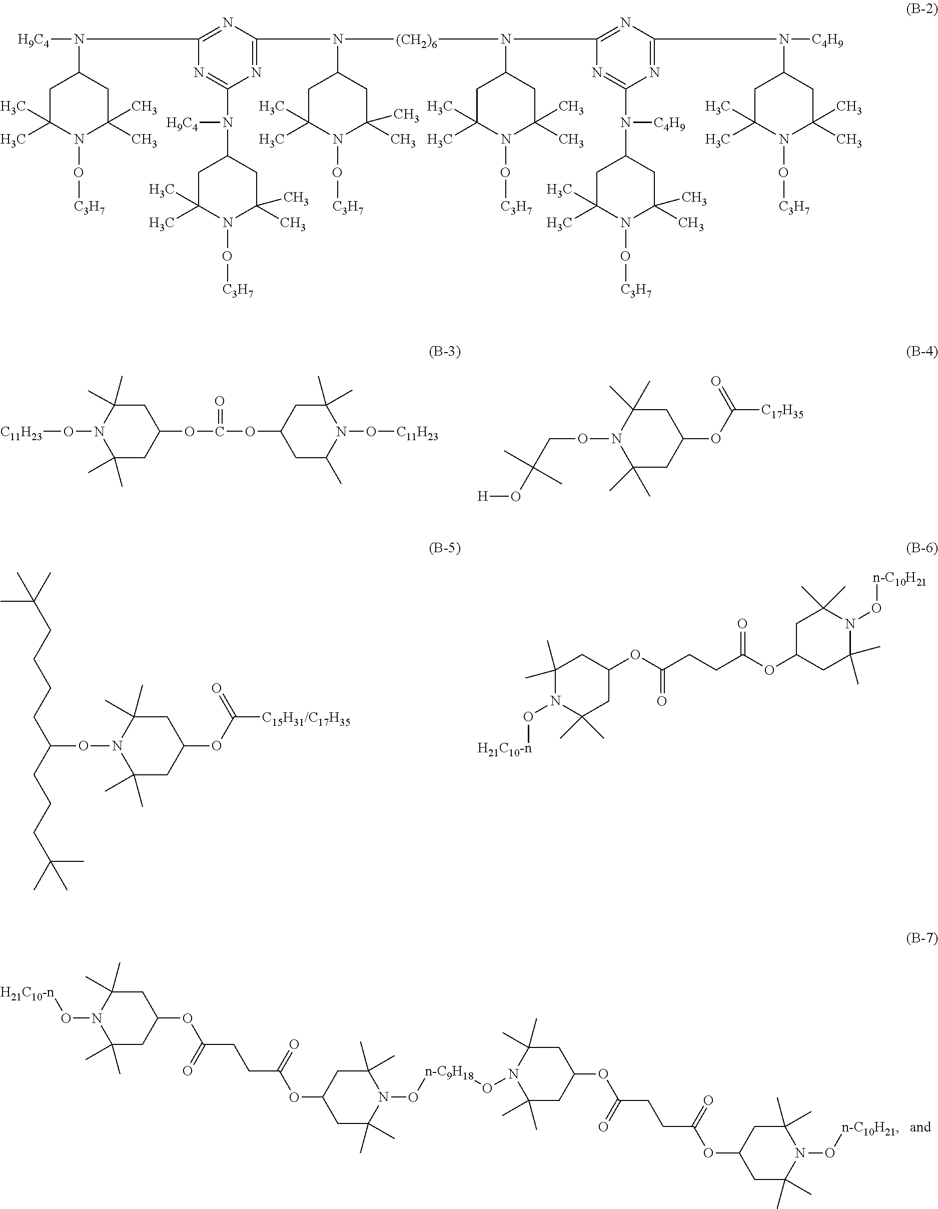

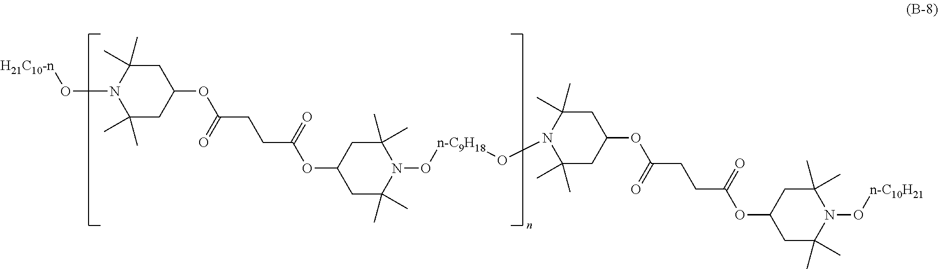

wherein n is 2.
31. The composition according to one or more of embodiments 1 to 30 further comprising at least one sterically hindered amine light stabilizer.
32. The composition according to embodiment 31, wherein the at least one sterically hindered amine light stabilizer is selected from the group consisting of carbonic acid bis(1-undecyloxy-2,2,6,6-tetramethyl-4-piperidyl)ester, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine and 4-butylamino-2,2,6,6-tetramethylpiperidine; a condensate of 1,6-hexanediamine and 2,4,6-trichloro-1,3,5-triazine as well as N,N-dibutylamine and 4-butylamino-2,2,6,6-tetramethylpiperidine; N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)amino)-s-triazine, 4-N-butyl-2-N,4-N-bis(2,2,6,6-tetramethylpiperidin-4-yl)-2-N-[6-[(2,2,6,6-tetramethylpiperidin-4-yl)amino]hexyl]-1,3,5-triazine-2,4-diamine, N,N′-bis(2,2,6,6-tetramethyl-4-piperidyl)N,N′-diformylhexamethylenediamine, 1,5,8,12-Tetrakis[4,6-bis(n-butyl-n-1,2,2,6,6-pentamethyl-4-piperidylamino)-1,3,5-triazin-2-yl]-1,5,8,12-tetraazadodecane, 1,3,5-Triazine-2,4,6-triamine, N,N′″-[1,2-ethane-diyl-bis[[[4,6-bis-[butyl(1,2,2,6,6-pentamethyl-4-piperidinyl)amino]-1,3,5-triazine-2-yl]imino]-3,1-propanediyl]]bis[N′,N″-dibutyl-N′,N″-bis-(1,2,2,6,6-pentamethyl-4-piperidinyl)-, 1,6-Hexanediamine, N,N′-bis(2,2,6,6-tetramethyl-4-piperidinyl)-, Polymers with morpholine-2,4,6-trichloro-1,3,5-triazine, poly(4-hydroxy-2,2,6,6-tetramethyl-1-piperidineethanol-alt-1,4-butanedioic acid), and mixtures thereof.
33. The composition according to one or more of embodiments 1 to 32 further comprising at least one additive selected from the group consisting of slip agents, anti-block agents, thermal fillers, pigments, anti-fog and anti-mist agents.
34. The composition according to embodiment 1, wherein the weight ratio of the stabilized organic material to the total weight of at least one compound of formula (A) and at least one UV absorber is in the range of 99.9:0.1 to 99:1.
35. The composition according to embodiment 1, wherein the weight ratio of the at least one compound of formula (A) to the at least one UV absorber is in the range of 1:50 to 50:1.
36. An additive mixture comprising:
   I. at least one compound of formula (A) as defined in embodiments 1, 15 and 16, and
   II. at least one UV absorber as defined in embodiments 1, 17 to 28.
37. The additive mixture according to embodiment 36, wherein the weight ratio of the at least one compound of formula (A) to the at least one UV absorber is in the range of 1:50 to 50:1.
38. An article comprising the composition according to one or more of embodiments 1 to 35.
39. Use of the additive mixture according to one or more of embodiments 36 to 38 for enhancing stability of the stabilized organic material exposed to light.

The following examples illustrate the invention in greater detail. All percentages and parts are by weight, unless stated otherwise.

### EXAMPLES

### Stabilizers Listed in Table 1 Below:

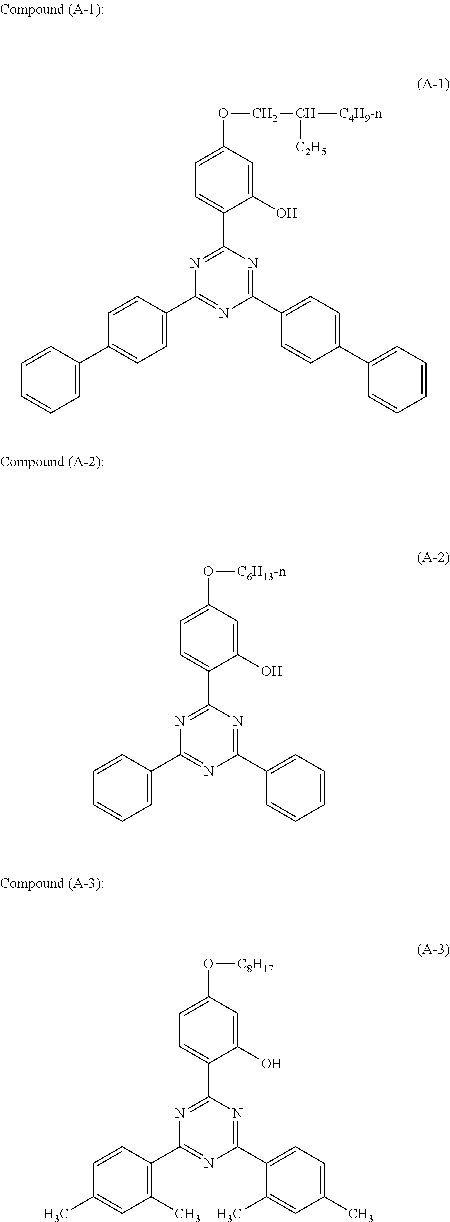

2-hydroxybenzophenone UV absorber (H-UV): 2-hydroxy-4-octyloxybenzophenone 2-(2′-hydroxyphenyl) benzotriazole (P-UV): 2-(2′-hydroxy-5′-methylphenyl)-benzotriazole Compound (B-3):

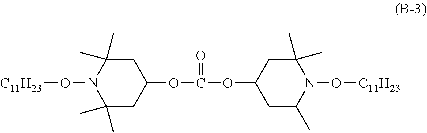

Cyanoacrylate UV absorber (C-UV): pentaerythritol tetrakis(2-cyano-3,3-diphenylacrylate) Compound (B-4):

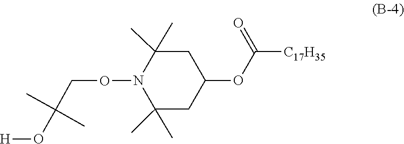

### Example A: Stabilization of Flexible Polyvinyl Chloride (f-PVC)

A base mixture of 64.73 phr PVC (Norvinyl®S7060 of Ineos), 32.36 phr diisononylphthalate plasticizer (Palatinol®N of BASF), 1.61 phr epoxidized soybean oil (Drapex®39 of Galata Chem.) and 1.30 phr heat stabilizer (Baerostab®CT 9063 X RF of Baerlocher; liquid CaZn stabilizer) was prepared (phr means parts per hundred rubber).

40 g of this PVC blend was mixed with UV absorber mixture and/or Hindered Amine Light Stabilizers (HALS) as described in table-1 and the obtained compound 2 in a glass beaker was then calendared for 8 minutes at 160° C. with f=1:1.2 on a two roll mill with a gap width of 0.4 mm. All the tested formulations are presented in Table 1.

The sheets obtained were then exposed to xenon light in accordance to ISO 4892-2 Cycle 1 (Xenon light, 2 borosilicate filters “S”, 0.51 W/m2 at 340 nm, Black Standard Temperature (BST) of 65° C.+/−2° C., Dry Bulb Temperature (DBT) of 38° C.+/−3° C., Relative Humidity (RH) of 50+/−5%, continuous light, 102 minutes dry followed by 18 minutes water spray).

The mechanical properties were measured according to ISO 527 5A—With Cutting. The results are shown in Table 2.

The color was measured in accordance to DIN 6167 (1980-01). The results are shown in Table 3.

Picture of the sample have been made using a Canon EOS 5DSR camera, using 4 light sources from ADEO Services led Floodlight 24100 100W IP65, 4000K and a visual assessment has been made after exposure to ISO 4892-2 cyclus 1. A notation from 1 to 5 has been given to the samples A note of 1 the worse note showing a higher dichlorination of the PVC samples whereas a 5 note is showing no dichlorination. The results are shown in the table 4a and Table 4b.

In the Table 4a we also indicate the state of the samples after 4000 hours exposure to ISO 4892-2 cyclus 1. B means that the sample are broken and/that the samples are still in a good shape.

TABLE 1
f-PVC composition

| | | Mechanical | Color | Visual |
|---|---|---|---|---|
| Labelling | Formulation | properties | properties | Assessment |
| 1. Non stabilized | 100% CaZn f-PVC | X | X | X |
| CaZn f-PVC | | | | |
| 2. Control A | 100% CaZn f-PVC + | X | | X |
| | 0.12% (H-UV) | | | |
| 3. | 100% CaZn f-PVC + | X | | X |
| | 0.09% (H-UV) + | | | |
| | 0.03% (A-1) | | | |
| 4. | 100% CaZn f-PVC + | X | | X |
| | 0.10% (H-UV) + | | | |
| | 0.02% (A-1) | | | |
| 5. Control B | 100% CaZn f-PVC + | X | X | X |
| | 0.12% (P-UV) | | | |
| 6. | 100% CaZn f-PVC + | X | | X |
| | 0.09% (P-UV) + | | | |
| | 0.03% (A-1) | | | |
| 7. | 100% CaZn f-PVC + | | X | X |
| | 0.10% (P-UV) + | | | |
| | 0.02% (A-1) | | | |
| 8. Control C | 100% CaZn f-PVC + | X | | X |
| | 0.12% (C-UV) | | | |
| 9. | 100% CaZn f-PVC + | X | | X |
| | 0.10% (C-UV) + | | | |
| | 0.02% (A-1) | | | |
| 10. Control D | 100% CaZn f-PVC + | X | | X |
| | 0.12% (B-3) + | | | |
| | 0.12% (H-UV) | | | |
| 11. | 100% CaZn f-PVC + | X | | X |
| | 0.12% (B-3) + | | | |
| | 0.10% (H-UV) + | | | |
| | 0.02% (A-1) | | | |
| 12. Control E | 100% CaZn f-PVC + | X | | X |
| | 0.12% (B-4) + | | | |
| | 0.12% (C-UV) | | | |
| 13. | 100% CaZn f-PVC + | X | | X |
| | 0.12% (B-4) + | | | |
| | 0.10% (C-UV) + | | | |
| | 0.02% (A-1) | | | |
| 14. Control F | 100% CaZn f-PVC + | | X | |
| | 0.12% (B-4) + | | | |
| | 0.12% (H-UV) | | | |
| 15 | 100% CaZn f-PVC + | | X | |
| | 0.12% (B-4) + | | | |
| | 0.10% (H-UV) + | | | |
| | 0.02% (A-1) | | | |
| 16 | 100% CaZn f-PVC + | | | X |
| | 0.10% (H-UV) + | | | |
| | 0.02% (A-2) | | | |
| 17 | 100% CaZn f-PVC + | | | X |
| | 0.10% (H-UV) + | | | |
| | 0.02% (A-3) | | | |
| 18 | 100% CaZn f-PVC + | | | X |
| | 0.09% (C-UV) + | | | |
| | 0.03% (A-1) | | | |
| 19. Control F | 100% CaZn f-PVC + | | | X |
| | 0.12% (B-4) + | | | |
| | 0.12% (P-UV) | | | |
| 20 | 100% CaZn f-PVC + | | | X |
| | 0.12% (B-4) + | | | |
| | 0.10% (P-UV) + | | | |
| | 0.02% (A-1) | | | |

X mentioned before the formulation indicates that the test mentioned in the respective columns has been conducted.

TABLE 2
mechanical properties.
Remaining % Tensile strength after 3000 hours to ISO 4892-2 Cyclus 1

| | | % TS after |
|---|---|---|
| Labelling | Formulation | 3000 hours |
| 1. Non stabilized | 100% CaZn f-PVC | Broken |
| CaZn f-PVC | | |
| 2. Control A | 100% CaZn f-PVC + | 40 |
| | 0.12% (H-UV) | |
| 3. | 100% CaZn f-PVC + | 74 |
| | 0.09% (H-UV) + | |
| | 0.03% (A-1) | |
| 4. | 100% CaZn f-PVC + | 61 |
| | 0.10% (H-UV) + | |
| | 0.02% (A-1) | |
| 5. Control B | 100% CaZn f-PVC + | 33 |
| | 0.12% (P-UV) | |
| 6. | 100% CaZn f-PVC + | 74 |
| | 0.09% (P-UV) + | |
| | 0.03% (A-1) | |
| 8. Control C | 100% CaZn f-PVC + | 57 |
| | 0.12% (C-UV) | |
| 9. | 100% CaZn f-PVC + | 73 |
| | 0.10% (C-UV) + | |
| | 0.02% (A-1) | |
| 10. Control D | 100% CaZn f-PVC + | 90 |
| | 0.12% (B-3) + | |
| | 0.12% (H-UV) | |
| 11. | 100% CaZn f-PVC + | 100 |
| | 0.12% (B-3) + | |
| | 0.10% (H-UV) + | |
| | 0.02% (A-1) | |
| 12. Control E | 100% CaZn f-PVC + | 95 |
| | 0.12% (B-4) + | |
| | 0.12% (C-UV) | |
| 13. | 100% CaZn f-PVC + | 100 |
| | 0.12% (B-4) + | |
| | 0.10% (C-UV) + | |
| | 0.02% (A-1) | |

Goal: the highest % tensile strength is requested over time

TABLE 3
Color behavior
Delta E after 4000 hours exposure to ISO 4892-2 Cyclus 1

| | | Delta E after |
|---|---|---|
| Labelling | Formulation | 4000 hours |
| 1. Non stabilized | 100% CaZn f-PVC | >30 |
| CaZn f-PVC | | |
| 5. Control B | 100% CaZn f-PVC + | 5.1 |
| | 0.12% (P-UV) | |
| 7. | 100% CaZn f-PVC + | 0.9 |
| | 0.10% (P-UV) + | |
| | 0.02% (A-1) | |
| 14. Control F | 100% CaZn f-PVC + | 1.9 |
| | 0.12% (B-4) + | |
| | 0.12% (H-UV) | |
| 15 | 100% CaZn f-PVC + | 1.5 |
| | 0.12% (B-4) + | |
| | 0.10% (H-UV) + | |
| | 0.02% (A-1) | |

The lowest color development is requested over exposure

TABLE 4a
Visual assessment of samples after 3000 hours exposure to ISO 4892-2 cyclus
1 and sample status after 4000 hours exposure to ISO 4892-2 cyclus 1

| | | | ISO 4892-2 |
|---|---|---|---|
| | | ISO 4892-2 | Cyclus 1 |
| | | Cyclus 1 | 3000 hours |
| Labelling | Formulations | 4000 hours | Visual assessment |
| 1. Non stabilized | 100% CaZn f-PVC | B | 1 |
| CaZn f-PVC | | | |
| 2. Control A | 100% CaZn f-PVC + | B | 2 |
| | 0.12% (H-UV) | | |
| 3 | 100% CaZn f-PVC + | / | 4 |
| | 0.09% (H-UV) + | | |
| | 0.03% (A-1) | | |
| 4 | 100% CaZn f-PVC + | / | 4-5 |
| | 0.10% (H-UV) + | | |
| | 0.02% (A-1) | | |
| 16 | 100% CaZn f-PVC + | B | 3 |
| | 0.10% (H-UV) + | | |
| | 0.02% (A-2) | | |
| 17 | 100% CaZn f-PVC + | B | 2-3 |
| | 0.10% (H-UV) + | | |
| | 0.02% (A-3) | | |
| 5. Control B | 100% CaZn f-PVC + | / | 2 |
| | 0.12% (P-UV) | | |
| 6 | 100% CaZn f-PVC + | / | 4-5 |
| | 0.09% (P-UV) + | | |
| | 0.03% (A-1) | | |
| 7 | 100% CaZn f-PVC + | / | 4 |
| | 0.10% (P-UV) + | | |
| | 0.02% (A-1) | | |
| 8. Control C | 100% CaZn f-PVC + | B | 4 |
| | 0.12% (C-UV) | | |
| 18 | 100% CaZn f-PVC + | / | 5 |
| | 0.09% (C-UV) + | | |
| | 0.03% (A-1) | | |
| 9 | 100% CaZn f-PVC + | / | 5 |
| | 010% (C-UV) + | | |
| | 0.02% (A-1) | | |

Visual assessment after 300 hours ISO 4892-2 cyclus 1 exposure: 1 Bad, 5 GoodSample status after 300 hours ISO 4892-2 cyclus 1: OK, B Brocken

TABLE 4b
Visual assessment of samples after 3000
hours exposure to ISO 4892-2 cyclus 1

| | | ISO 4892-2 |
|---|---|---|
| | | Cyclus 1 |
| | | 6000 hours |
| Labelling | Formulations | Visual assessment |
| 1. Non stabilized | 100% CaZn f-PVC | 1 |
| CaZn f-PVC | (300 hours) | |
| 10. Control D | 100% CaZn f-PVC + | 1-2 |
| | 0.12% (B-3) + 0.12% | |
| | (H-UV) | |
| 11 | 100% CaZn f-PVC + | 2-3 |
| | 0.12% (B-3) + 0.10% | |
| | (H-UV) + 0.02% (A-1) | |
| 19. Control F | 100% CaZn f-PVC + | 1 |
| | 0.12% (B-4) + 0.12% | |
| | (P-UV) | |
| 20 | 100% CaZn f-PVC + | 2-3 |
| | 0.12% (B-4) + 0.10% | |
| | (P-UV) + 0.02% (A-1) | |
| 12. Control E | 100% CaZn f-PVC + | 1-2 |
| | 0.12% (B-4) + 0.12% | |
| | (C-UV) | |
| 13 | 100% CaZn f-PVC + | 2-3 |
| | 0.12% (B-4) + 0.10% | |
| | (C-UV) + 0.02% (A-1) | |

Visual assessment after 300 hours ISO 4892-2 cyclus 1 exposure: 1 Bad, 5 Good

### Example B: Stabilization of Rigid Polyvinyl Chloride (r-PVC)

### Ingredients Listed in Tables 5 to 8 Below:

PVC: suspension PVC with K-value of 70;
Calcium carbonate (CaCO₃): commercial grade containing 98% calcium carbonate, mean particle size 2 micron, d98 8 micron;
Epoxidized soybean oil (ESBO): viscosity at 25° C.: 320 cps [Drapex 39];
Heat stabilizer: Calcium/Zinc (Ca/Zn), free from nonylphenol, ethylhexanoic acid and p-t-butylbenzoic acid [Baerostab CT 9063 X RF];
Titanium dioxide (TiO₂): rutile, produced by the chloride process, surface-treated (with aluminum, silicone and polysiloxane compounds);
Impact modifier: acrylic, 2-Propenoic acid, 2-methyl-, methyl ester, polymer with butyl 2-propenoate and 2-ethylhexyl 2-propenoate;
HALS 1: 1,3,5-Triazine-2,4,6-triamine, N, N′″-[1,2-ethane-diyl-bis[[[4,6-bis-[butyl(1,2,2,6,6-pentamethyl-4-piperidinyl) amino]-1,3,5-triazine-2-yl]imino]-3,1-propanediyl]] bis [N′, N″-dibutyl-N′, N″-bis(1,2,2,6,6-pentamethyl-4-piperidinyl);
HALS 2: poly(4-hydroxy-2,2,6,6-tetramethyl-1-piperidineethanol-alt-1,4-butanedioic acid); Compound (B-4)

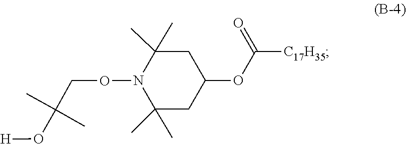

UV-absorber 1: Phenol, 2-(5-chloro-2H-benzotriazol-2-yl)-6-(1,1-dimethylethyl)-4-methyl;

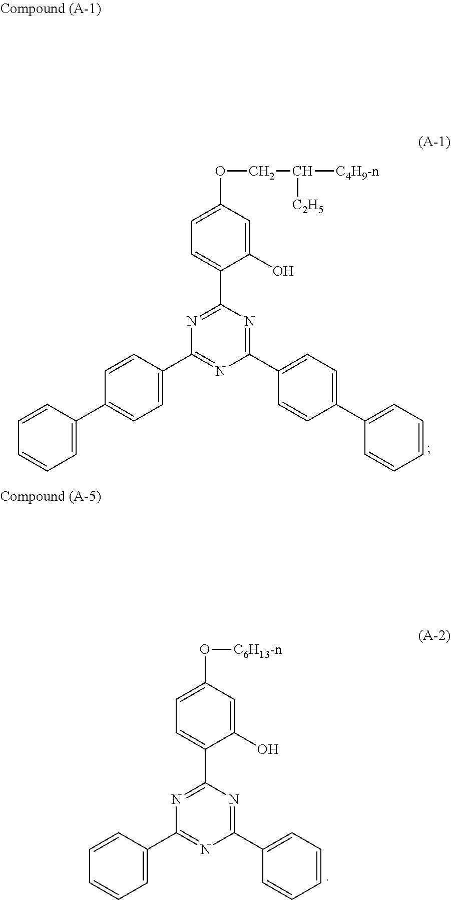

### Process:

The process consisted in a pre-mixing of the ingredient in a tumble mixer, followed by two-roll calendering during 6 minutes at 160° C., rotation speed 29 rpm, friction rate 1:1.2, roll gap 0.5 mm. The obtained compounds were press-formed to obtain plaques of 1 mm thickness (pressing 1 minute at 165° C. at 100 bar, followed by cooling 1 minute at 100 bar).

### Accelerated Weathering Test:

The plaques were submitted to accelerated UV-exposure according to the standard EN ISO 4892-2 cycle 1 (cycles of 102 minutes of light+18 minutes of light+water spray, with irradiance of 60 W/m² @300-400 nm by xenon light, black standard temperature of 65° C., dry bulb temperature of 38° C., relative humidity of 50%). Recalls were made at various times, given in hours in the below Tables 5 to 8.

### Measurements at Given Recalls:

Color coordinate b*, in CIELAB units, according to ISO 4582, where negative values indicate blue and positive values indicate yellow;

Yellowness Index, without unit, according to ASTM E313; deltaE*, in CIELAB units, taken as the square root of the squares of the differences in the L*, a* and b* CIELAB color coordinates at time of recall minus time zero, as defined in ISO 11664-4.

The color properties are shown in the Tables 5 to 7.

Roughness, in micron, arithmetic average of the absolute values of the profile height deviations from the mean line, as defined in EN ISO 4288.

The results are shown in the Table 8.

TABLE 5
b* [CIELAB units] over exposure according to EN ISO 4892-2 cycle 1

| | | Exposure duration [hours] | | | | | |
|---|---|---|---|---|---|---|---|
| Example | Formulation | 7971 | 9007 | 10008 | 10998 | 12019 | 12997 |
| Comparative | 100 phr PVC | 10.1 | 10.0 | 10.6 | 10.6 | 13.2 | 15.7 |
| Example 1 | 6 phr CaCO₃ | | | | | | |
| | 2 phr ESBO | | | | | | |
| | 2 phr Ca/Zn | | | | | | |
| | 0.20 phr TiO₂ | | | | | | |
| | 0.05 phr HALS 1 | | | | | | |
| | 0.05 phr HALS 2 | | | | | | |
| | 0.10 phr Compound (B-4) | | | | | | |
| | 0.15 phr UV-absorber 1 | | | | | | |
| Example 1 | 100 phr PVC | 8.4 | 8.4 | 8.7 | 9.0 | 9.8 | 10.6 |
| | 6 phr CaCO₃ | | | | | | |
| | 2 phr ESBO | | | | | | |
| | 2 phr Ca/Zn | | | | | | |
| | 0.20 phr TiO₂ | | | | | | |
| | 0.05 phr HALS 1 | | | | | | |
| | 0.05 phr HALS 2 | | | | | | |
| | 0.10 phr Compound (B-4) | | | | | | |
| | 0.15 phr UV-absorber 1 | | | | | | |
| | 0.05 phr Compound (A-2) | | | | | | |
| Example 2 | 100 phr PVC | 8.0 | 9.1 | 10.4 | 10.5 | 10.4 | 10.4 |
| | 6 phr CaCO₃ | | | | | | |
| | 2 phr ESBO | | | | | | |
| | 2 phr Ca/Zn | | | | | | |
| | 0.20 phr TiO₂ | | | | | | |
| | 0.05 phr HALS 1 | | | | | | |
| | 0.05 phr HALS 2 | | | | | | |
| | 0.10 phr Compound (B-4) | | | | | | |
| | 0.15 phr UV-absorber 1 | | | | | | |
| | 0.03 phr Compound (A-1) | | | | | | |

The above results showed that the yellow coordinates b* were significantly lower for the r-PVC stabilized with the inventive Examples containing one compound of formula (A) and at least one UV absorber.

TABLE 6
Yellowness Index [—] over exposure according to EN ISO 4892-2 cycle 1

| | | Exposure duration [hours] | | | | | |
|---|---|---|---|---|---|---|---|
| Example | Formulation | 7971 | 9007 | 10008 | 10998 | 12019 | 12997 |
| Comparative | 100 phr PVC | 17.1 | 17.0 | 18.0 | 17.9 | 22.8 | 27.4 |
| Example 1 | 6 phr CaCO₃ | | | | | | |
| | 2 phr ESBO | | | | | | |
| | 2 phr Ca/Zn | | | | | | |
| | 0.20 phr TiO₂ | | | | | | |
| | 0.05 phr HALS 1 | | | | | | |
| | 0.05 phr HALS 2 | | | | | | |
| | 0.10 phr Compound (B-4) | | | | | | |
| | 0.15 phr UV-absorber 1 | | | | | | |
| Example 1 | 100 phr PVC | 14.2 | 14.1 | 14.7 | 15.1 | 16.6 | 18.2 |
| | 6 phr CaCO₃ | | | | | | |
| | 2 phr ESBO | | | | | | |
| | 2 phr Ca/Zn | | | | | | |
| | 0.20 phr TiO₂ | | | | | | |
| | 0.05 phr HALS 1 | | | | | | |
| | 0.05 phr HALS 2 | | | | | | |
| | 0.10 phr Compound (B-4) | | | | | | |
| | 0.15 phr UV-absorber 1 | | | | | | |
| | 0.05 phr Compound (A-2) | | | | | | |
| Example 2 | 100 phr PVC | 13.5 | 15.4 | 17.6 | 17.8 | 17.7 | 17.6 |
| | 6 phr CaCO₃ | | | | | | |
| | 2 phr ESBO | | | | | | |
| | 2 phr Ca/Zn | | | | | | |
| | 0.20 phr TiO₂ | | | | | | |
| | 0.05 phr HALS 1 | | | | | | |
| | 0.05 phr HALS 2 | | | | | | |
| | 0.10 phr Compound (B-4) | | | | | | |
| | 0.15 phr UV-absorber 1 | | | | | | |
| | 0.03 phr Compound (A-1) | | | | | | |

The above results showed that the yellowness index values were significantly lower for the r-PVC stabilized with the inventive Examples containing one compound of formula (A) and at least one UV absorber.

TABLE 7
deltaE* [CIELAB units] over exposure according to EN ISO 4892-2 cycle 1

| | | Exposure duration [hours] | | | | | |
|---|---|---|---|---|---|---|---|
| Example | Formulation | 7971 | 9007 | 10008 | 10998 | 12019 | 12997 |
| Comparative | 100 phr PVC | 8.4 | 8.2 | 8.4 | 8.8 | 8.4 | 8.0 |
| Example 2 | 6 phr CaCO₃ | | | | | | |
| | 5 phr Impact modifier | | | | | | |
| | 2 phr ESBO | | | | | | |
| | 2 phr Ca/Zn | | | | | | |
| | 0.20 phr TiO₂ | | | | | | |
| | 0.05 phr HALS 1 | | | | | | |
| | 0.05 phr HALS 2 | | | | | | |
| | 0.10 phr Compound (B-4) | | | | | | |
| | 0.15 phr UV-absorber 1 | | | | | | |
| Example 3 | 100 phr PVC | 8.2 | 7.7 | 7.7 | 7.8 | 7.8 | 7.0 |
| | 6 phr CaCO₃ | | | | | | |
| | 5 phr Impact modifier | | | | | | |
| | 2 phr ESBO | | | | | | |
| | 2 phr Ca/Zn | | | | | | |
| | 0.20 phr TiO₂ | | | | | | |
| | 0.05 phr HALS 1 | | | | | | |
| | 0.05 phr HALS 2 | | | | | | |
| | 0.10 phr Compound (B-4) | | | | | | |
| | 0.15 phr UV-absorber 1 | | | | | | |
| | 0.03 phr Compound (A-1) | | | | | | |

The above results showed that the discoloration values, defined by deltaE*, were significantly lower for the r-PVC stabilized with the inventive Example 3 containing one compound of formula (A) and at least one UV absorber.

TABLE 8
Roughness [micron] over exposure according to EN ISO 4892-2 cycle 1

| | | Exposure duration [hours] | | | | | |
|---|---|---|---|---|---|---|---|
| Example | Formulation | 7971 | 9007 | 10008 | 10998 | 12019 | 12997 |
| Comparative | 100 phr PVC | 1.0 | 1.0 | 1.0 | 1.2 | 1.4 | 1.5 |
| Example 2 | 6 phr CaCO₃ | | | | | | |
| | 5 phr Impact modifier | | | | | | |
| | 2 phr ESBO | | | | | | |
| | 2 phr Ca/Zn | | | | | | |
| | 0.20 phr TiO₂ | | | | | | |
| | 0.05 phr HALS 1 | | | | | | |
| | 0.05 phr HALS 2 | | | | | | |
| | 0.10 phr Compound (B-4) | | | | | | |
| | 0.15 phr UV-absorber 1 | | | | | | |
| Example 3 | 100 phr PVC | 0.8 | 0.6 | 0.7 | 0.8 | 1.1 | 1.3 |
| | 6 phr CaCO₃ | | | | | | |
| | 5 phr Impact modifier | | | | | | |
| | 2 phr ESBO | | | | | | |
| | 2 phr Ca/Zn | | | | | | |
| | 0.20 phr TiO₂ | | | | | | |
| | 0.05 phr HALS 1 | | | | | | |
| | 0.05 phr HALS 2 | | | | | | |
| | 0.10 phr Compound (B-4) | | | | | | |
| | 0.15 phr UV-absorber 1 | | | | | | |
| | 0.03 phr Compound (A-1) | | | | | | |

The above results showed that the surface roughness values were significantly lower for the r-PVC stabilized with the inventive Example 3 containing one compound of formula (A) and at least one UV absorber.

1. A composition comprising:
i. a stabilized organic material;
ii. at least one compound of formula (A),
wherein
E₁ 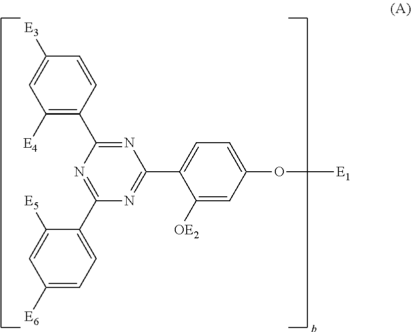
is hydrogen, C₁-C₁₈ alkyl, a group of formula P 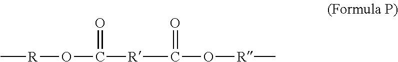
wherein, R, R′ and R″ independently of one another are C₁-C₁₈ alkylene,
b is an integer in the range of 1 to 3, or
a group of Formula Q 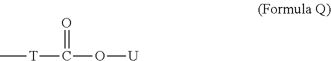
wherein, T and U independently of one another are linear or branched C₁-C₁₈ alkyl,
and
E₂, E₃, E₄, E₅, and E₆ independently of one another are hydrogen, C₁-C₁₈ alkyl, phenyl or phenyl substituted by 1, 2 or 3 C₁-C₄alkyl, or a group of Formula Q 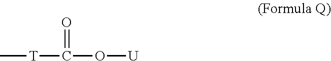
wherein, T and U independently of one another are linear or branched C₁-C₁₈ alkyl; and
iii. at least one UV absorber.

2. The composition according to claim 1, wherein the stabilized organic material is selected from the group consisting of polyethylene, polypropylene, polyurethane, styrenic polymer, a polyvinylchloride, and mixtures thereof.

3. The composition according to claim 1, wherein the stabilized organic material is polyvinylchloride.

4. The composition according to claim 1, wherein the polyvinylchloride is rigid, semirigid, or flexible polyvinylchloride.

5. The composition according to claim 1, wherein the stabilized organic material comprises at least one plasticizer, at least one heat stabilizer, and mixtures thereof.

6. The composition according to claim 5, wherein the at least one plasticizer is selected from the group consisting of phthalates, dialkyl cyclohexan-1,2-dicarboxylates, dialkyl cyclohexan-1,3-dicarboxylates, dialkyl cyclohexan-1,4-dicarboxylates, dialkyl terephthalates, esters of trimellitic acid, trialkyltrimellitates, alkyl benzoates, dibenzoic esters of glycols, pentaerythritol esters, hydroxybenzoic esters, monoesters, esters of saturated monocarboxylic acids, esters of unsaturated monocarboxylic acids, esters of saturated dicarboxylic acids, esters of unsaturated dicarboxylic acids, amides and esters of aromatic sulfonic acids, alkylsulfonic esters, glycerol esters, glycon esters, isosorbide esters, phosphoric esters, citric triesters, acylated trialkyl citrates, alkyl pyrrolidone derivatives, dialkyl 2,5-furandicarboxylates, dialkyl 2,5-tetrahydrofurandicarboxylates, epoxide plasticizers, epoxidized vegetable oils and epoxidized fatty acid monoalkylesters, chlorinated hydrocarbons, polymer plasticizers, polyesters made of aliphatic and/or aromatic polycarboxylic acids with at least dihydric alcohols, and mixtures thereof.

7. The composition according to claim 5, wherein the at least one heat stabilizer is selected from the group consisting of metal salts of fatty acid, mixed metal stabilizers, organotin stabilizers, lead stabilizers, organic based stabilizers and mixtures thereof.

8. The composition according to claim 1, wherein E₁ is hydrogen, C₁-C₈ alkyl, a group of formula P, wherein b is an integer in the range of 1 to 2, or a group of formula Q, and E₂, E₃, E₄, E₅, and E₆ independently of one another are hydrogen, C₁-C₄ alkyl, phenyl, or a group of formula Q.

9. The composition according to claim 1, wherein the at least one compound of formula (A) is selected from the formulae (A-1), (A-2), (A-3), (A-4), and (A-5).

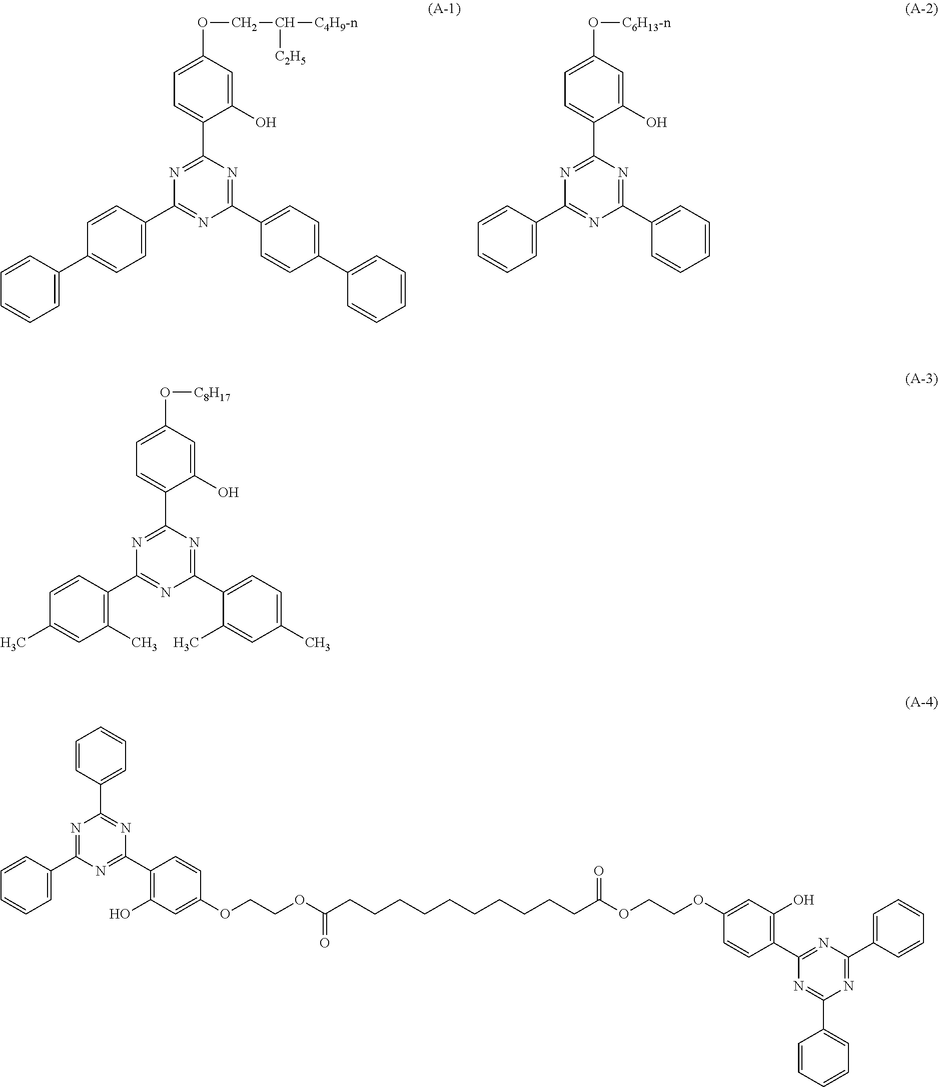

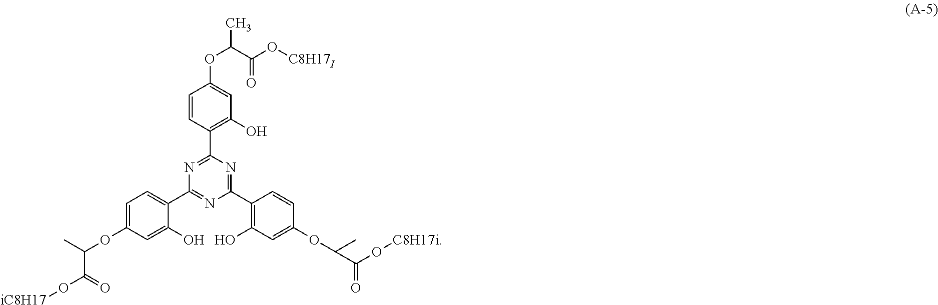

10. The composition according to claim 1, wherein the UV absorber is selected from the group consisting of 2-(2′-hydroxyphenyl) benzotriazoles, 2-hydroxybenzophenones, 2-(2-hydroxyphenyl)-1,3,5-triazines, esters of substituted and unsubstituted benzoic acids, cyanoacrylates, oxanilide, benzoxazinone and mixtures thereof.

11. The composition according to claim 1, wherein the weight ratio of the stabilized organic material to the total weight of the at least one compound of formula (A) and the at least one UV absorber is in the range of 99.9:0.1 to 99:1.

12. An additive mixture comprising the at least one compound of formula (A) and the at least one UV absorber as defined in claim 1.

13. The additive mixture according to claim 12, wherein the weight ratio of the at least one compound of formula (A) to the at least one UV absorber is in the range of 1:50 to 50:1.

14. An article comprising the composition according to claim 1.

15. A method for enhancing stability of a stabilized organic material exposed to light comprising adding the additive mixture according to claim 12 to the stabilized organic material.
